(19) United States
(12) Patent Application Publication
(10) Pub. No.: US 2026/0133638 A1
(43) Pub. Date: May 14, 2026

(54) METHOD AND APPARATUS FOR CONVEYING SPATIAL INFORMATION OF SURROUNDINGS

(71) Applicant: ForSight Assistive Devices, LLC, North Huntingdon, PA (US)

(72) Inventor: Lyman Petrosky, North Huntingdon, PA (US)

(21) Appl. No.: 19/359,862

(22) Filed: Oct. 16, 2025

Related U.S. Application Data
(60) Provisional application No. 63/708,354, filed on Oct. 17, 2024.

(51) Int. Cl. G06F 3/01; G06V 10/764

(52) U.S. Cl. CPC G06F 3/016; G06F 3/014; G06V 10/764

(57) ABSTRACT

A device for assisting visually impaired individuals includes a depth sensing camera to capture range data within a field of view. A computational unit processes this range data to classify objects in regions ahead of the device wearer. The device further comprises wearable pads incorporating haptic actuators. Each region in the field of view may correspond to a specific position on a wearable pad where a haptic actuator is mounted. The computational unit may sequentially activate the actuators to enhance the wearer's ability to discern the relative locations of haptic stimuli on the skin. Each actuator may be programmed with a unique activation pattern, including variations in amplitude, vibration frequency, pulse count, and/or duration, to convey information about the classified objects in the corresponding region. An electronic drive circuit may control the haptic actuators based on the processed depth data, and a battery may power all device components.

### RELATED APPLICATION

Under provisions of 35 U.S.C. §119(e), the Applicant claims benefit of U.S. Provisional Application No. 63/708,354 filed on Oct. 17, 2024, and having inventors in common, which is incorporated herein by reference in its entirety.

It is intended that the referenced application may be applicable to the concepts and embodiments disclosed herein, even if such concepts and embodiments are disclosed in the referenced application with different limitations and configurations and described using different examples and terminology.

### FIELD OF DISCLOSURE

The present disclosure generally relates to assistive technology for individuals with visual impairments. More specifically, it pertains to navigation aids that provide spatial awareness in complex environments through advanced sensing technologies and haptic feedback systems.

### BACKGROUND

In some situations, visually impaired individuals may face challenges navigating through unfamiliar or dynamic environments. For example, conventional navigation aids like white canes and guide dogs may provide limited information about the surrounding space. However, the conventional strategy relies on these traditional tools for obstacle detection and avoidance. This often causes problems because the conventional strategy does not offer comprehensive spatial awareness of the environment beyond the immediate reach of the cane or the guidance of the dog. In addition, aids such as canes typically require the user to physically contact the objects in the surroundings in order to assess their proximity and cannot be used for assessing suitable paths beyond the immediate area. For example, a white cane may detect obstacles at ground level but may miss overhead hazards or fail to provide information about the overall layout of the space.

As a visually impaired person navigates through an environment it is very advantageous for them to understand what obstacles and other impediments lay along the path ahead. As an example, FIG. 1 shows a representative view of a visually impaired person (henceforth the “user”), 100, navigating an urban environment. Although user 100 is using a cane 101, most of the obstacles in the immediate environment, such as a light post 102, person 103, vehicle 104, and curb 105 are undetected (and undetectable) for the user in their current position, because the user is too far from these objects to touch them with the cane. These undetected obstacles represent hazards to the user. Even if the user is familiar with the area, transient obstacles (e.g., person 103 and vehicle 104) remain hazardous. It is advantageous to the user to have information about both the location and types of these obstacles in advance of what would be possible using a cane.

Efforts to address these limitations have led to the development of various electronic travel aids. Some imaging devices have been developed to convey information via retinal implants, but these devices are invasive, very expensive, and do not adequately convey distances. There have also been attempts to use sensing systems with haptic feedback arrays, but these devices generally produce unsatisfactory results because the brain's ability to perceive spatial information via the skin is very limited. These devices may attempt to provide additional sensory information to visually impaired users. However, these solutions struggle to convey complex spatial data in an intuitive and easily interpretable manner.

Conventional systems for assisting visually impaired individuals primarily include tactile and audio-based aids. These systems, such as tactile paving and auditory traffic signals, help in simple navigation tasks but often fall short in providing detailed spatial awareness. Tactile maps and Braille signs offer static information, which cannot adapt to dynamic changes in the environment. Audio aids can communicate data about the environment but can be intrusive and often do not provide information about the spatial orientation and distance of objects with precision. Moreover, these conventional aids do not facilitate an understanding of the environment in a comprehensive and intuitive manner, limiting the user's ability to navigate effectively in more complex or unfamiliar settings.

One challenge in developing such systems may be balancing the amount and complexity of information provided with the user's ability to process and understand that information through touch. Overloading the user with too much haptic feedback may lead to confusion, while providing too little information may not offer significant advantages over traditional navigation aids.

Additional challenges arise when considering the fluctuating nature of urban environments where visually impaired individuals must navigate. Construction zones, temporary barriers, and even day-to-day changes like parked vehicles or street vendors can create new obstacles that are not accounted for in static navigation tools. These dynamic changes can pose significant risks if not detected and communicated effectively to the user.

Furthermore, environmental factors such as weather conditions also impact navigation aids. For instance, rain or snow can obscure tactile ground cues and make auditory signals less discernible. These conditions further complicate the ability of visually impaired individuals to rely solely on traditional navigation methods.

Another technical problem is the limitation in distance that current aids can detect. While tactile and audio aids are useful in close-range navigation, they do not provide information about objects that are further away until the user is in close proximity. This limitation restricts the user's ability to plan their route effectively, potentially leading to delays or the need for sudden changes in direction which can be disorienting.

Moreover, crowded environments present a unique set of challenges. In places like busy streets, shopping malls, or public transport systems, the ability to navigate safely and efficiently is critical. However, the density of people and the variety of obstacles increase the complexity of the environment, making it difficult for traditional aids to provide clear and timely guidance to avoid collisions.

Lastly, the cognitive load on the user to interpret signals from multiple aids simultaneously can be overwhelming. Managing and integrating information from tactile, auditory, and potentially other sensory feedback systems require significant mental effort, which can be taxing and may lead to fatigue or errors in navigation. This underscores the need for a more integrated solution that can simplify the processing of spatial information.

Visually impaired individuals face significant challenges in navigating environments due to the limited effectiveness of traditional aids such as canes and guide dogs. These aids offer only immediate spatial awareness and require physical contact with objects to detect them, which is not feasible for obstacles that are out of reach or not directly in the path of the user. Furthermore, dynamic and crowded environments introduce additional navigational challenges that these conventional aids are unable to address effectively. They struggle to provide real-time updates and detailed spatial orientation, which are crucial for safe and efficient navigation in such settings. Accordingly, there is a need for a feedback device that provides visually impaired users with readily-interpretable information and the area in which they are operating, without the need to physically contact each obstacle within the area. This would significantly improve the autonomy and safety of visually impaired individuals by enabling them to navigate more complex and variable spaces effectively.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

A device for sensing distances to obstacles and converting that information into a meaningful pattern of haptic sensations may comprise a multiplicity of depth sensing devices. The device may comprise a computational unit to receive sensor input and execute processing of the data. The device may comprise software algorithms to locate and classify obstacles within the data. The device may comprise a plurality of wearable pads with a multiplicity of haptic actuator devices to create localized haptic sensations. The device may comprise electrical drivers to actuate the haptic actuators in specific patterns defined by the software. The patterns may convey meaningful information about the surroundings.

A system for conveying spatial information to a visually impaired user may comprise a depth sensing device configured to capture depth data of an environment. A processing unit may be configured to receive the depth data from the depth sensing device. The processing unit may segment the depth data into a plurality of regions. The processing unit may classify objects within each of the plurality of regions. The processing unit may generate haptic actuation patterns based on the classified objects. A wearable haptic array may comprise a plurality of haptic actuators, wherein each haptic actuator may correspond to one of the plurality of regions. The processing unit may be further configured to sequentially activate the plurality of haptic actuators according to the generated haptic actuation patterns to convey spatial information about the environment to the user.

A method for conveying spatial information to a visually impaired user may comprise capturing depth data of an environment using a depth sensing device. The method may include segmenting the depth data into a plurality of regions. The method may include classifying objects within each of the plurality of regions. The method may include generating haptic actuation patterns based on the classified objects. The method may include sequentially activating a plurality of haptic actuators on a wearable haptic array according to the generated haptic actuation patterns, wherein each haptic actuator may correspond to one of the plurality of regions. The sequential activation may convey spatial information about the environment to the user.

An apparatus for conveying spatial information to a visually impaired user may comprise a wearable haptic array comprising a plurality of haptic actuators. The apparatus may comprise a processing unit configured to receive depth data of an environment from a depth sensing device. The processing unit may segment the depth data into a plurality of regions. The processing unit may classify objects within each of the plurality of regions. The processing unit may generate haptic actuation patterns based on the classified objects. The processing unit may sequentially activate the plurality of haptic actuators according to the generated haptic actuation patterns to convey spatial information about the environment to the user. Each haptic actuator may correspond to one of the plurality of regions.

A wearable haptic device for conveying spatial information to a visually impaired user may comprise a wearable pad configured to be worn on a body part of the user. The device may comprise a plurality of haptic actuators arranged on the wearable pad in a spatial configuration corresponding to regions of an environment. The device may comprise a wireless receiver configured to receive haptic actuation commands from a remote processing unit. The device may comprise a controller configured to receive the haptic actuation commands via the wireless receiver. The controller may interpret the haptic actuation commands to determine actuation patterns for the plurality of haptic actuators. The controller may sequentially activate the plurality of haptic actuators according to the determined actuation patterns to create a wave-like progression of haptic sensations that conveys spatial information about the environment to the user.

A method for enhancing perception of spatial information by a visually impaired user may comprise capturing depth data and image data of an environment. The method may include fusing the depth data and image data to generate a three-dimensional representation of the environment. The method may include segmenting the three-dimensional representation into a plurality of regions. The method may include classifying objects within each of the plurality of regions based on both depth information and semantic information from the image data. The method may include generating haptic actuation patterns based on the classified objects, wherein the haptic actuation patterns may comprise a first signature for regions classified as clear of obstacles, a second signature for regions containing static obstacles, a third signature for regions containing dynamic obstacles, and a fourth signature for regions containing elevation changes. The method may include mapping each of the plurality of regions to a corresponding haptic actuator in a wearable haptic array. The method may include sequentially activating the haptic actuators in the wearable haptic array according to the generated haptic actuation patterns to create a wave-like progression of haptic sensations that may convey enriched spatial information about the environment to the user.

A system for assisting navigation of a visually impaired user may comprise a depth sensing device configured to capture depth data of an environment. The system may comprise an image capture device configured to capture image data of the environment. The system may comprise a wearable haptic array comprising a plurality of haptic actuators arranged to correspond to different spatial regions relative to the user. The system may comprise a processing unit configured to receive the depth data and the image data. The processing unit may generate a three-dimensional map of the environment based on the depth data and the image data. The processing unit may identify navigable paths and obstacles within the three-dimensional map. The processing unit may classify the obstacles based on semantic information from the image data. The processing unit may generate haptic navigation instructions based on the identified paths and classified obstacles. The processing unit may translate the haptic navigation instructions into sequential actuation patterns for the plurality of haptic actuators. The system may comprise a controller configured to activate the plurality of haptic actuators according to the sequential actuation patterns to guide the user along a selected navigable path while providing spatial awareness of surrounding obstacles.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 shows a representative view of a person attempting to navigate an urban location;

FIG. 2 is a functional block representation of the proposed device with a wearable hand unit illustrated;

FIG. 3 is an example of the preferred implementation as worn by the user;

FIG. 4A is a representation of a depth camera field of view and obstacles detected, from a top-down view;

FIG. 4B is a representation of a depth camera field of view and obstacles detected, from a side view;

FIG. 5A shows the top-down view shown in FIG. 4, rotated for ease of understanding and divided based on the array of haptics units;

FIG. 5B shows how detected objects map to the haptics unit locations on the wearable pads;

FIG. 6 is a diagram of the data acquisition, processing, and output according to at least one aspect of the present disclosure;

FIG. 7A is an example of one possible haptic actuation signature for a region that is clear of obstacles;

FIG. 7B is an example of one possible haptic actuation-signature for a nearby obstacle;

FIG. 7C is an example of one possible haptic actuation-signature for a step or offset;

FIG. 7D is an example of one possible haptic actuation-signature for a nearby person;

FIG. 8A is a first example of the sequential actuation of haptic actuators;

FIG. 8B is a second example of the sequential actuation of haptic actuators; and

FIG. 9 is a block diagram of a computing device for use with the system of FIG. 2.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely to provide a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of the term herein. To the extent that the meaning of a term used herein-as understood by the ordinary artisan based on the contextual use of such term-differs in any way from any particular dictionary definition of such term, it is intended that the meaning of the term as understood by the ordinary artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

The technical problem being solved relates to the limited spatial awareness capabilities of conventional navigation aids for visually impaired individuals. Traditional mobility tools such as white canes and guide dogs may only provide information about obstacles within immediate physical reach or direct contact range. This constraint may create hazardous situations where users cannot detect remote obstacles, moving objects, or environmental features that lie beyond the operational range of their primary navigation aids.

The problem may manifest across multiple scenarios where advance spatial awareness becomes critical for safe navigation. In urban environments, visually impaired individuals may encounter complex obstacle arrays including light posts, vehicles, pedestrians, and curbs that remain undetectable until physical contact occurs. These undetected obstacles may represent significant hazards to the user, particularly when transient obstacles such as moving people or vehicles change position dynamically. Even in familiar areas, the presence of temporary or mobile obstacles may create unpredictable navigation challenges that conventional aids cannot address effectively.

Indoor environments may present additional challenges where traditional navigation methods may prove insufficient. Complex building layouts, furniture arrangements, and architectural features may require advance spatial information to enable efficient path planning and obstacle avoidance. The limited detection range of conventional aids may force users to rely on memorized navigation patterns that become ineffective when environmental changes occur or when navigating unfamiliar spaces.

Dynamic environments may pose particular difficulties where real-time spatial awareness becomes essential for safe navigation. Moving obstacles such as vehicles, pedestrians, or equipment may approach from directions that remain outside the detection range of traditional mobility aids. The inability to detect these dynamic hazards in advance may result in dangerous encounters or navigation errors that could have been avoided with extended spatial awareness capabilities.

The primary use case addresses the fundamental limitation that conventional navigation aids may only provide contact-based or immediate-range obstacle detection. A visually impaired user navigating an urban environment may use a white cane to detect ground-level obstacles through physical contact, but this approach may fail to provide information about overhead hazards, distant obstacles, or the overall spatial layout of the surrounding area. The user may encounter situations where multiple obstacles exist at varying distances and heights, requiring comprehensive spatial awareness to formulate effective navigation strategies.

The sequential nature of contact-based detection may create additional inefficiencies where users must physically probe each potential obstacle individually. This approach may prove time-consuming and may not provide sufficient advance warning for rapid decision-making in dynamic environments. The lack of simultaneous multi-directional awareness may limit the user's ability to assess alternative navigation paths or to anticipate approaching hazards from multiple directions.

Furthermore, conventional aids may not provide sufficient information about obstacle characteristics or classifications. A white cane may detect the presence of an obstacle but may not distinguish between a stationary pole, a moving person, or a vehicle. This limitation may prevent users from making informed decisions about appropriate navigation strategies or response actions based on the specific nature of detected obstacles.

The problem extends to situations where environmental conditions may affect the effectiveness of traditional navigation aids. Weather conditions, surface variations, or acoustic environments may impact the performance of guide dogs or the tactile feedback provided by white canes. These limitations may create situations where users require alternative or supplementary spatial awareness methods to maintain safe navigation capabilities.

The technical challenge involves developing a solution that may overcome these fundamental limitations while providing intuitive and comprehensible spatial information to users. The solution must address the brain's limited ability to process complex simultaneous haptic stimuli while still conveying meaningful spatial and classification information about multiple obstacles across extended detection ranges.

The system may address these challenges through a comprehensive approach that may combine advanced sensing technologies with carefully designed haptic feedback mechanisms. The solution may utilize depth sensing devices to capture environmental data beyond the reach of traditional mobility aids, providing users with advance spatial awareness that may enable proactive navigation decisions rather than reactive contact-based responses.

The core solution may comprise a depth sensing device configured to capture environmental data within a defined field of view. The depth sensing device may utilize technologies such as time-of-flight cameras, structured light cameras, stereo camera systems, LIDAR, or ultrasonic sensors to measure distances to multiple points across the surrounding environment. This sensing capability may provide comprehensive spatial information about obstacles, pathways, and environmental features that may remain undetectable through traditional navigation methods.

A processing unit may receive depth data from the sensing device and may execute algorithms to segment the captured environmental information into discrete spatial regions. Each region may correspond to a specific area within the field of view, allowing the system to analyze and classify objects or features within defined spatial boundaries. The processing unit may classify detected objects within each region based on characteristics derived from the depth data, potentially distinguishing between clear pathways, static obstacles, dynamic obstacles such as moving people or vehicles, and elevation changes such as curbs or steps.

The system may generate haptic actuation patterns based on the classified objects within each spatial region. These patterns may comprise distinctive signatures that may vary in temporal amplitude, vibration frequency, and duration to convey specific information about obstacle types and distances. A clear region may be assigned a brief, low-amplitude pulse signature, while obstacle regions may receive longer, higher-amplitude signatures with intensity potentially correlating to proximity. Dynamic obstacles may be distinguished through amplitude variations or specific frequency patterns, while elevation changes may be indicated through interrupted or stepped pulse sequences.

A wearable haptic array may comprise multiple haptic actuators arranged in a spatial configuration that may correspond to the segmented regions of the environment. Each haptic actuator may be positioned to represent a specific directional zone within the depth sensing device's field of view, creating a direct mapping between environmental regions and tactile feedback locations. The wearable haptic array may be configured for placement on various body locations including hands, arms, torso, or other suitable areas where tactile perception may be optimized.

The system may employ sequential activation of the haptic actuators to enhance user perception and comprehension of spatial information. Rather than simultaneously activating multiple actuators, which may create sensory overload and confusion, the system may activate actuators in temporal sequences that may create wave-like progressions across the user's skin. This sequential approach may simulate familiar navigation concepts such as the sweeping motion of a white cane or the radial scanning pattern of radar systems.

The sequential activation may follow various patterns depending on the desired user experience and environmental conditions. A cane simulation mode may activate actuators in a sweeping pattern from one side to the other and back, replicating the familiar probing motion that visually impaired users may already understand. Alternatively, a radar simulation mode may activate actuators based on distance relationships, with closer obstacles triggering earlier actuations in the sequence, creating an outward-moving wave effect that may provide intuitive distance information.

The system may provide perceptible signals for all spatial regions, including those classified as clear of obstacles. This approach may ensure that users receive comprehensive spatial information and may aid in creating coherent mental maps of their environment. The wave-like progression of sensations may help users distinguish between individual haptic stimuli and may prevent the loss of spatial context that may occur with isolated or random actuations.

The solution may extend beyond basic obstacle detection to include semantic classification of detected objects. Integration with image capture devices may enable the system to distinguish between different types of obstacles such as poles, people, vehicles, or architectural features. This enhanced classification capability may allow for more sophisticated haptic signatures that may convey not only the presence and distance of obstacles but also their nature and potential behavior characteristics.

Dynamic obstacle detection may represent a particularly valuable aspect of the solution. The system may identify moving objects such as approaching vehicles or pedestrians and may provide specialized alerts or modified haptic patterns to indicate the dynamic nature of these hazards. Emergency situations may trigger additional notification methods including audio alarms or specially designated haptic actuators that may not participate in normal spatial feedback operations.

The solution may accommodate various user preferences and environmental conditions through configurable parameters. Haptic intensity, sequence timing, and signature characteristics may be adjustable to match individual sensitivity levels and comfort requirements. The system may also provide adaptive coverage, potentially focusing on immediate hazards when rapid navigation decisions may be required while providing comprehensive area coverage during routine navigation.

Multiple wearable haptic arrays may be employed simultaneously to provide broader spatial coverage or enhanced resolution within specific environmental zones. The system may coordinate feedback across multiple arrays to maintain coherent spatial representation while potentially providing specialized information through different body locations.

The solution may operate in various environmental conditions and may integrate with existing mobility aids rather than replacing them. Users may continue to employ white canes or guide dogs while benefiting from the extended spatial awareness provided by the depth sensing and haptic feedback system. This complementary approach may preserve familiar navigation techniques while adding valuable advance warning capabilities.

Battery management and wireless communication systems may enable practical deployment of the solution across distributed components. The depth sensing and processing components may operate independently of the wearable haptic arrays, connected through wireless links that may allow flexible positioning and movement during navigation activities.

The system may provide continuous real-time operation with processing capabilities sufficient to analyze environmental data and generate haptic feedback at rates that may support natural walking speeds and dynamic environmental changes. This real-time performance may ensure that spatial information remains current and actionable as users move through their environment.

The present disclosure includes many aspects and features. Moreover, while many aspects and features relate to, and are described in, the context of a spatial information conveying platform, embodiments of the present disclosure are not limited to use only in this context.

### I. Platform Overview

This overview is provided to introduce a selection of concepts in a simplified form that are further described below. This overview is not intended to identify key features or essential features of the claimed subject matter. Nor is this overview intended to be used to limit the claimed subject matter's scope.

The present disclosure describes a device configured to detect remote objects that may be obstacles in a user's surroundings, classify the detected objects, and convey that information in a meaningful way to the user via multiple haptic actuators worn by the user. The device is noninvasive, provides different haptic actuation signatures for different object distances and/or types, and utilizes a sequential actuation scheme that enhances the user's ability to comprehend the relative spatial positions of objects in the local area. In some embodiments, the haptic actuation scheme can be sequenced to simulate the movement of a virtual probing cane (white cane).

The present disclosure describes a wearable device to aid a visually impaired individual (henceforth, the “user”). Although the present disclosure is written with reference to visually impaired users, it is contemplated that the various aspects disclosed herein are applicable to any user, not just visually impaired users. The device may be configured to detect remote objects that may be obstacles in the user's surroundings, classify those objects, and convey information regarding the detected and classified objects in a meaningful way to the user via haptic actuators placed on a plurality of wearable pads. In this way, the wearable device may assist the user in navigating through their environment.

The device may include, for example, a distance sensing system using one or more sensors, a computational device, and a plurality of wearable pads with individually controlled haptic actuators. In some embodiments, a method of translating sensor information into spatial and temporal patterns of haptic actuator actuation may be provided by one or more computing devices embedded in the device. In this way, the device may be configured to convey information about the spatial surroundings to the user.

The user may wear one or more pads, each of which includes a compliant assemblage of one or more haptic actuators, to create a multitude of localized haptic sensations over an extended expanse of the user's skin. The pads may be placed over thin clothing or in direct contact with the skin. Locations of haptic actuators on the pads may be designed to correspond to locations of predefined regions in the field of view of the sensors looking at the environment.

The haptic actuators may be activated in a plurality of ways. For example, in some embodiments, the haptic actuators may be activated sequentially along one the principal directions of the scanned area, either by distance or by angular direction. In this way, the haptic actuators may improve the user's perception of the spatial information being provided through the haptic actuation pattern.

The haptic actuators may actuated such that the actuators produce different sensations. This may be achieved in various ways. In one instance, by way of non-limiting example, the device may be configured to cause a variation of in one or more of temporal amplitude, vibration frequency and total duration to convey to the user the type of object or obstacle at each corresponding location. In some embodiments, more than one haptic actuator type may be utilized to provide additional perception differentiation in the applied haptic sensations.

In some embodiments, additional means of notification may be employed to alert the user to situations of high importance. Examples would include (but need not be limited to) audio alarms and/or audio verbal messages such as “vehicle right” and specially designated haptic actuators that do not participate in the normal functioning of the wearable haptic array.

One or more depth sensing devices (e.g., cameras) may be provided. The depth sensing devices may be worn or otherwise carried by the user. The depth-sensing devices may provide data for an array of measurements of the distances to one or more (e.g., all) objects and surfaces within the camera's field of view. The depth data may be updated periodically to effectively provide continuous information about the distances to all surfaces within the camera's operational range limits. Other implementations in which the user is not required to carry the system components other than the wearable haptic array is contemplated to be within the scope and spirit of the present disclosure. By way of non-limiting examples, the additional system components may be carried by a cart, a service animal, a wheelchair, a walker, and/or the like.

One or more computing devices may operate in conjunction with the depth sensing devices. The computing devices may be distributed throughout a system comprised of, for example, the device, the wearable, and, for example, a user's portable computing device (e.g., a smartphone). In some embodiments, the system may communicate with a remote processing unit (e.g., remote server) to assist in the processing. In this way, the computing system can benefit from, for example, a neural network or other artificial intelligence to improve, for example, the recognition aspects and/or the image processing aspects of the present disclosure.

Embodiments of the present disclosure may comprise methods, systems, and a computer readable medium comprising, but not limited to, at least one of the following:
A. A Depth Sensing Device
B. A Computing Device
C. A Plurality of Wearable Actuators

In some embodiments, the present disclosure may provide an additional set of modules for further facilitating the software and hardware platform. The additional set of modules may comprise, but not be limited to:
D. A Carrying Device

Details with regards to each module are provided below. Although modules are disclosed with specific functionality, it should be understood that functionality may be shared between modules, with some functions split between modules, while other functions duplicated by the modules. Furthermore, the name of each module should not be construed as limiting upon the functionality of the module. Moreover, each component disclosed within each module can be considered independently, without the context of the other components within the same module or different modules. Each component may contain functionality defined in other portions of this specification. Each component disclosed for one module may be mixed with the functionality of other modules. In the present disclosure, each component can be claimed on its own and/or interchangeably with other components of other modules.

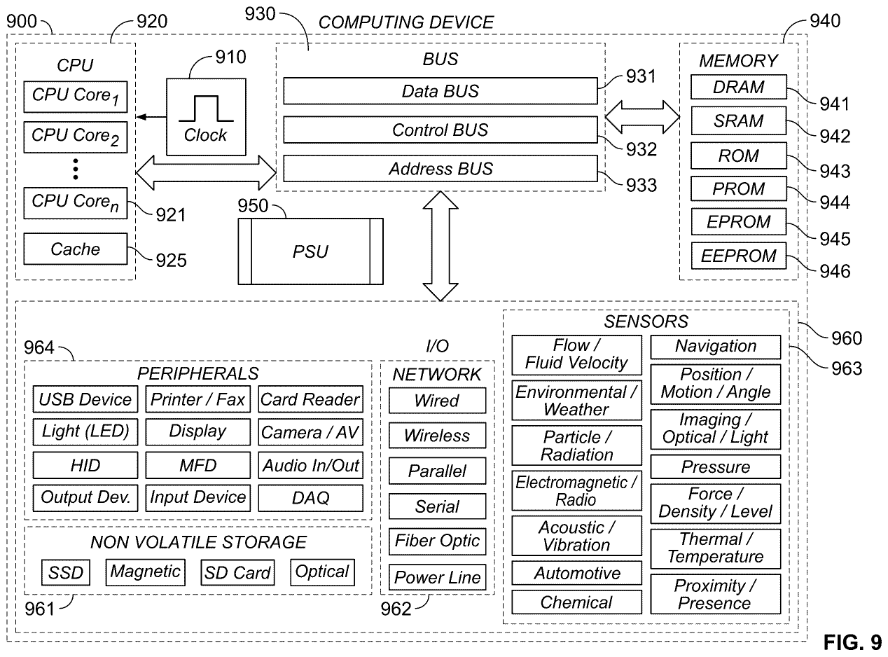

The following depicts an example of a method of a plurality of methods that may be performed by at least one of the aforementioned modules, or components thereof. Various hardware components may be used at the various stages of the operations disclosed with reference to each module. For example, although methods may be described to be performed by a single computing device, it should be understood that, in some embodiments, different operations may be performed by different networked elements in operative communication with the computing device. For example, at least one computing device 900 (as shown in FIG. 9) may be employed in the performance of some or all of the stages disclosed with regard to the methods. Similarly, an apparatus may be employed in the performance of some or all of the stages of the methods. As such, the apparatus may comprise at least those architectural components as found in computing device 900.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in orders that differ from the ones disclosed below. Moreover, various stages may be added or removed without altering or departing from the fundamental scope of the depicted methods and systems disclosed herein.

Consistent with embodiments of the present disclosure, a method may be performed by at least one of the modules disclosed herein. The method may be embodied as, for example, but not limited to, computer instructions which, when executed, perform the method. The method may comprise the following stages:
capturing depth data of an environment using a depth sensing device;
segmenting the depth data into a plurality of regions;
classifying objects within each of the plurality of regions;
generating haptic actuation patterns based on the classified objects; and
activating a plurality of haptic actuators on a wearable haptic array according to the generated haptic actuation patterns, wherein each haptic actuator corresponds to one of the plurality of regions,

Although the aforementioned method has been described to be performed by a spatial information conveying platform, it should be understood that computing device 900 may be used to perform the various stages of the method. Furthermore, in some embodiments, different operations may be performed by different networked elements in operative communication with computing device 900. For example, a plurality of computing devices may be employed in the performance of some or all of the stages in the aforementioned method. Moreover, a plurality of computing devices may be configured much like a single computing device 900. Similarly, an apparatus may be employed in the performance of some or all stages in the method. The apparatus may also be configured much like computing device 900.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Platform Configuration

As a visually impaired person navigates through an environment it is very advantageous for them to understand what obstacles and other impediments lay along the path ahead.

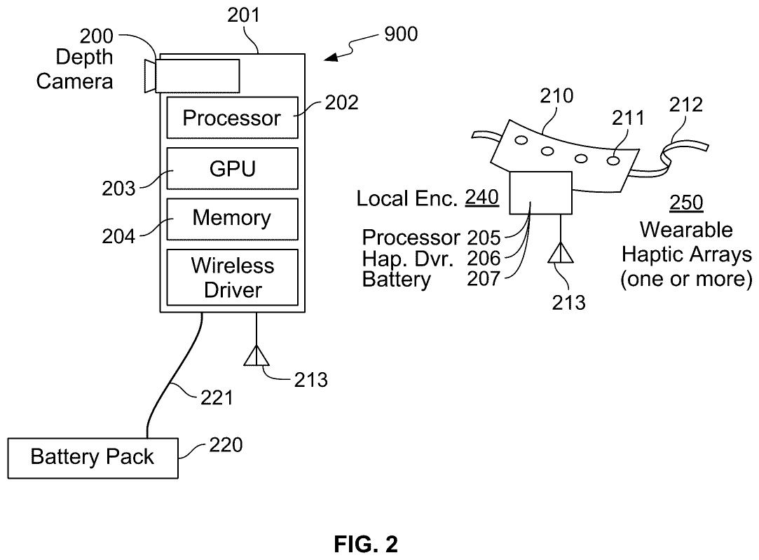

Referring now to FIG. 2, a spatial information conveying system may comprise a depth sensing device 200 configured to capture depth data of an environment within its field of view. The depth sensing device 200 may be integrated within an electronics enclosure 201 that may house various processing components. The electronics enclosure 201 may comprise a processing unit 202 configured to receive and analyze the depth data from the depth sensing device 200. An optional graphical processing unit 203 may be included to accelerate computationally intensive image processing operations. Memory 204 may store software algorithms and temporarily buffer captured depth data during processing operations.

The system may further comprise one or more wearable haptic arrays 250, each comprising a wearable pad 210 configured to be positioned on the user's body. Multiple haptic actuators 211 may be arranged on the wearable pad 210 in a spatial configuration that may correspond to regions within the depth sensing device's field of view. A local control enclosure 240 may be integrated with each wearable haptic array 250, containing a dedicated processor 205 and haptic output drivers 206 configured to control individual haptic actuators 211. A local battery 207 may power the haptic actuators 211 and associated control electronics within each wearable haptic array 250.

A wireless communication link 213 may connect the electronics enclosure 201 to each wearable haptic array 250, enabling real-time transmission of actuation commands from the processing unit 202 to the local processors 205. The wireless communication may utilize protocols such as Bluetooth, WiFi, or proprietary radio frequency communication methods to maintain reliable data transmission during user movement. A binding system 212 may secure each wearable haptic array 250 to the user's body, utilizing adjustable straps, elastic bands, or other fastening mechanisms configured to maintain proper positioning during navigation activities.

An external battery pack 220 may provide power to the electronics enclosure 201 through a cable connection 221. The battery pack 220 may be positioned separately from the electronics enclosure 201 to distribute weight and may be secured to the user's belt, carried in a bag, or integrated into other wearable accessories. The system may be configured to operate continuously for extended periods, with power management circuits regulating energy consumption across all system components.

The depth sensing device 200 may utilize various ranging technologies to measure distances to objects within its operational field of view. Time-of-flight cameras may emit infrared light pulses and measure the time required for reflected light to return to the sensor, enabling precise distance calculations to multiple points simultaneously. Structured light cameras may project known patterns onto the environment and analyze pattern distortions to extract depth information. Stereo camera systems may utilize two offset lenses to capture slightly different views of the same scene, with depth information calculated through triangulation methods similar to human binocular vision.

Alternative depth sensing implementations may include LIDAR systems that may emit laser pulses and measure reflected signals with high precision. Ultrasonic ranging devices may supplement primary depth sensing with multi-directional coverage capabilities. The depth sensing device 200 may operate across various environmental conditions, including low-light situations where infrared-based systems may provide advantages over visible light cameras.

The processing unit 202 may execute algorithms configured to segment captured depth data into discrete regions corresponding to the spatial arrangement of haptic actuators 211 on the wearable haptic arrays 250. Each region may be analyzed to classify objects or features present within that spatial zone. Classification algorithms may distinguish between clear pathways, static obstacles such as poles or walls, dynamic obstacles such as moving people or vehicles, and elevation changes such as curbs or steps.

Object classification may utilize depth-based analysis combined with optional image recognition when RGB cameras may be integrated alongside depth sensing devices. Machine learning models may be employed to improve classification accuracy over time, with the system potentially learning to recognize specific object types or environmental features relevant to navigation safety. The processing unit 202 may generate haptic actuation patterns based on the classified objects within each region, with different signature patterns assigned to different object types and distances.

The haptic actuators 211 may comprise various technologies configured to produce distinguishable tactile sensations. Eccentric Rotating Mass motors may generate vibrations at controllable frequencies and amplitudes. Linear Resonant Actuators may provide precise frequency control for creating distinctive haptic signatures. Piezoelectric actuators may produce fine tactile sensations with rapid response times. Multiple actuator types may be integrated within the same wearable pad 210 to expand the range of perceivable haptic signatures.

Each haptic actuator 211 may be individually controlled by the local processor 205 through dedicated haptic output drivers 206. The local processor 205 may receive actuation commands from the main processing unit 202 via the wireless communication link 213 and may interpret these commands to generate specific activation patterns for each actuator. The haptic output drivers 206 may regulate current, voltage, and timing parameters to produce the desired tactile sensations with precise control over amplitude, frequency, and duration characteristics.

The wearable pad 210 may be constructed from flexible, breathable materials configured for comfortable extended wear. The pad may conform to body contours while maintaining proper positioning of haptic actuators 211 relative to the user's skin. The binding system 212 may provide adjustable securing mechanisms to accommodate different body sizes and wearing preferences while maintaining consistent actuator positioning during movement.

The system may support multiple wearable haptic arrays 250 operating simultaneously to provide broader spatial coverage or enhanced resolution within specific environmental zones. The processing unit 202 may coordinate haptic feedback across multiple arrays to maintain coherent spatial representation while potentially providing specialized information through different body locations. Users may wear arrays on hands, arms, torso, or other suitable body areas where tactile perception may be optimized.

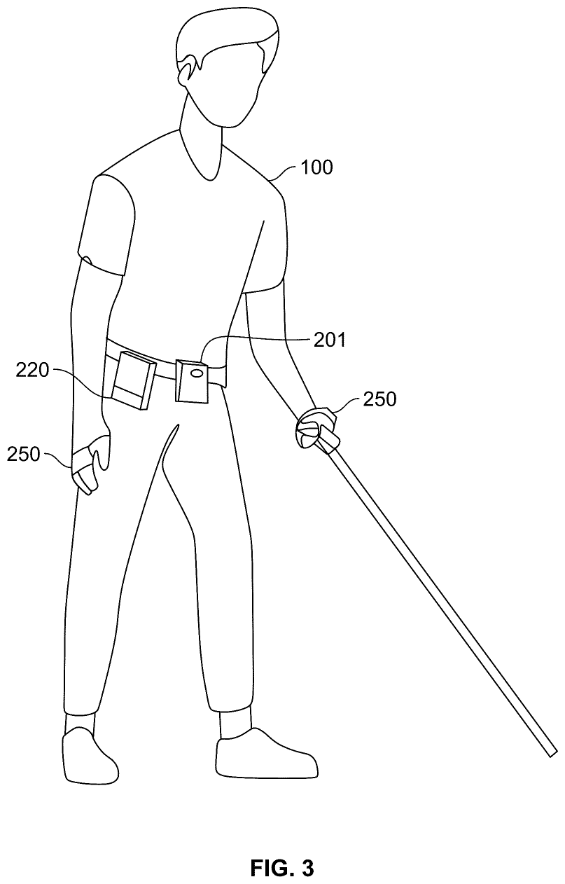

Referring now to FIG. 3, the spatial information conveying system may be configured for practical deployment in real-world navigation scenarios. A user 100 may wear the electronics enclosure 201 attached to a neck band-style mount, headband, hat (e.g., a baseball cap, visor, or similar), belt or other body-mounted location, positioning the integrated depth sensing device 200 to capture environmental data in the direction of travel. The external battery pack 220 may be secured to the user's belt, placed in a pocket, or carried in a bag to provide portable power for extended operation periods.

The wearable haptic arrays 250 may be positioned on the user's hands as shown, with haptic actuators 211 arranged to correspond to spatial regions within the depth sensing device's field of view. The hand-mounted configuration may provide intuitive spatial mapping, with actuator positions directly corresponding to directional zones relative to the user's forward path. Alternative mounting locations may include arms, torso, or other body areas where tactile sensitivity may be suitable for perceiving haptic feedback patterns.

The system may operate independently of traditional mobility aids, allowing users to continue employing white canes or working with guide dogs while benefiting from enhanced spatial awareness capabilities. The depth sensing and haptic feedback may provide advance warning of obstacles beyond the reach of traditional aids, complementing rather than replacing existing navigation techniques.

In alternative implementations, the system components other than the wearable haptic arrays 250 may be mounted on mobility aids, service animals, wheelchairs, or other assistive devices. This configuration may reduce the burden on users while maintaining the spatial awareness benefits provided by the haptic feedback system. The wireless communication link 213 may enable flexible positioning of system components while preserving real-time feedback capabilities.

The system may be configured for operation across various environmental conditions and lighting situations. Indoor and outdoor environments may present different challenges for depth sensing, with the system adapting sensing parameters and processing algorithms accordingly. Weather resistance may be incorporated into system components to ensure reliable operation across diverse conditions encountered during daily navigation activities.

User training may be provided to familiarize individuals with the haptic signature patterns corresponding to different object types and distances. The system may include configurable parameters allowing users to adjust haptic intensity, timing, and signature characteristics to match personal sensitivity levels and preferences. Calibration procedures may optimize the system performance for individual users and specific environmental conditions.

The system may incorporate power management features configured to extend operational time while maintaining real-time performance requirements. Low-power modes may be available during periods of reduced activity, with automatic activation when movement or environmental changes may be detected. Battery status indicators may provide users with awareness of remaining operational time and charging requirements.

The spatial information conveying system may provide visually impaired users with comprehensive environmental awareness capabilities that may significantly enhance navigation safety and confidence. The combination of advanced depth sensing, intelligent processing, and intuitive haptic feedback may enable users to perceive and respond to environmental features and obstacles that would otherwise remain undetected until physical contact occurs.

The system may incorporate multiple implementation approaches to accommodate various user preferences and environmental conditions. In one embodiment, the depth sensing device 200 may be configured as a modular component that may be detached from the electronics enclosure 201 and positioned independently. This modular approach may allow users to mount the depth sensing device 200 on existing mobility aids such as white canes or guide dog harnesses while maintaining wireless communication with the processing components. The modular depth sensing device 200 may include its own local battery and processing capabilities to reduce latency in initial data capture and preprocessing.

Alternative mounting configurations may position the depth sensing device 200 at different heights and orientations relative to the user's body. A chest-mounted configuration may provide a higher vantage point for obstacle detection, while a waist-mounted arrangement may offer better detection of ground-level hazards. Multiple depth sensing devices 200 may be employed simultaneously to provide broader spatial coverage, with each device covering a specific angular sector of the environment. The processing unit 202 may correlate data from multiple depth sensing devices to create a comprehensive environmental map spanning a wider field of view than achievable with a single sensor.

The wearable haptic arrays 250 may be implemented in various configurations to optimize user comfort and spatial information transfer. In addition to hand-mounted arrays, embodiments may include forearm-mounted configurations where haptic actuators 211 may be arranged in linear or grid patterns along the user's arm. The forearm configuration may provide a larger surface area for haptic feedback while maintaining intuitive spatial mapping between environmental regions and actuator positions. Torso-mounted haptic arrays may distribute actuators across the user's chest or back, providing spatial information through a broader contact area that may be less prone to interference during hand-based activities.

Multi-pad implementations may employ coordinated haptic feedback across different body locations to convey enhanced spatial information. A primary haptic array positioned on the dominant hand may provide detailed obstacle information for immediate navigation decisions, while a secondary array on the non-dominant hand or arm may convey broader environmental context or approaching dynamic obstacles. The processing unit 202 may coordinate activation patterns across multiple arrays to maintain coherent spatial representation while avoiding conflicting or overwhelming sensory inputs.

The haptic actuators 211 may comprise hybrid implementations combining multiple actuator technologies within individual units. A hybrid actuator may integrate an eccentric rotating mass motor for general vibration feedback with a piezoelectric element for fine tactile sensations, allowing the same actuator to produce a broader range of distinguishable haptic signatures. Linear resonant actuators may be paired with thermal elements to provide temperature variations as additional signature characteristics, enabling more complex object classification schemes. Microfluidic actuators may be integrated with traditional vibration motors to create pressure sensations combined with vibrational feedback.

Advanced haptic signature implementations may incorporate temporal patterns that extend beyond simple amplitude and frequency variations. Burst patterns may utilize sequences of rapid on-off cycles with varying intervals to create distinctive rhythmic signatures for specific object types. Crescendo patterns may gradually increase or decrease amplitude over time to indicate approaching or receding dynamic obstacles. Multi-frequency patterns may simultaneously activate different actuator elements at different frequencies to create complex harmonic signatures that may be more easily distinguished by users.

The sequential activation patterns may be customized based on user experience and preference profiles stored in memory 204. Novice users may receive slower sequential progressions with longer dwell times at each actuator position to allow adequate processing time for spatial comprehension. Experienced users may benefit from accelerated sequential patterns that provide rapid environmental updates for dynamic navigation scenarios. Adaptive timing algorithms may automatically adjust sequential activation rates based on detected user movement speed and environmental complexity.

Emergency alert implementations may override normal sequential patterns when immediate hazards may be detected. A vehicle approaching from the side may trigger rapid bilateral activation of all actuators on the corresponding side of the body, creating an unmistakable warning signal that may be distinguished from normal environmental feedback. Emergency patterns may utilize maximum amplitude settings and distinctive temporal signatures such as rapid triple-pulse sequences that may not be employed for normal obstacle classification.

The wireless communication link 213 may implement advanced protocols to ensure reliable real-time data transmission between system components. Frequency-hopping spread spectrum techniques may provide robust communication in environments with significant radio frequency interference. Multiple redundant communication channels may be established between the processing unit 202 and each wearable haptic array 250 to ensure continuous operation even if individual channels experience interference or obstruction.

Power management implementations may employ intelligent battery allocation strategies across distributed system components. The external battery pack 220 may serve as a primary power source for the electronics enclosure 201 while individual wearable haptic arrays 250 maintain local batteries 207 for autonomous operation during brief communication interruptions. Wireless power transfer capabilities may allow the external battery pack 220 to recharge local batteries 207 in the wearable haptic arrays 250 during periods of close proximity, extending overall system operational time.

Environmental adaptation features may automatically adjust system parameters based on detected conditions. Indoor environments may trigger higher resolution depth sensing with shorter range settings optimized for architectural features and furniture detection. Outdoor environments may activate longer range sensing modes with enhanced dynamic obstacle detection algorithms tuned for vehicle and pedestrian identification. Weather detection through optional sensors may modify haptic feedback intensity to compensate for reduced tactile sensitivity caused by cold conditions or protective clothing.

Integration with external navigation systems may enhance the spatial information provided to users. Global positioning system data may be combined with depth sensing information to provide location-aware obstacle databases that may pre-load known environmental features for familiar areas. Smartphone integration may enable cloud-based processing capabilities for advanced object recognition while maintaining local processing for time-critical obstacle detection functions. Social networking features may allow users to share obstacle information and environmental updates with other system users in the same geographic area.

Machine learning implementations may continuously improve system performance through user interaction analysis. Pattern recognition algorithms may identify user preferences for specific haptic signatures and automatically optimize activation patterns for improved comprehension. Environmental learning may build databases of frequently encountered obstacles and their typical locations, enabling predictive feedback that may alert users to expected hazards before they may be detected by sensors.

The system may incorporate fail-safe mechanisms to ensure reliable operation during component failures or adverse conditions. Redundant processing capabilities may be distributed across multiple computing elements to maintain basic functionality if the primary processing unit 202 experiences difficulties. Degraded operation modes may provide simplified haptic feedback using fewer actuators or reduced signature complexity when system resources may be limited. Manual override controls may allow users to directly activate specific haptic patterns for testing or emergency signaling purposes.

Calibration and training implementations may provide structured learning experiences for new users. Interactive training modes may guide users through recognition exercises for different haptic signatures while providing audio feedback to confirm correct interpretation. Progressive difficulty levels may gradually introduce more complex environmental scenarios as users develop proficiency with basic obstacle detection and classification. Performance tracking may monitor user improvement over time and suggest personalized training exercises to address specific areas of difficulty.

FIG. 2 shows one possible embodiment of a spatial information conveying device consistent with the present disclosure. The device includes one or more depth sensing devices (e.g., cameras) 200 built into an electronics enclosure 201. Other camera placement and connection means are contemplated to be within the scope of the present disclosure.

Electronics enclosure 201 may comprise various computing components. For example, assembly 201 may comprise a processing unit 202, an optional graphical processing unit 203, memory 204, and a battery pack 220 housed internally or connected via cable 221. The electronics assembly 201 may be connected via a wireless communications link 213 to one or more wearable haptic arrays 250, comprising wearable pad 210, a local control enclosure, 240, with processor, 205, haptic output drivers 206, battery 207, wireless communication link 213, multiplicity of haptic actuators 211 attached thereon, and binding system 212 which may be configured to hold the wearable haptic array in place where worn.

The depth sensing device 200 may be configured to capture depth data of the environment within its field of view. In some embodiments, the depth sensing device 200 may comprise a time-of-flight camera. The time-of-flight camera may emit pulses of infrared light and measure the time taken for the light to bounce back from objects in the environment. This allows the camera to determine the distance to various points in its field of view, creating a three-dimensional depth map.

In other embodiments, the depth sensing device 200 may comprise a structured light camera. The structured light camera may project a known pattern of infrared dots onto the scene and analyze how the pattern is distorted when it hits objects. This distortion allows the camera to calculate depth information for the scene.

Alternatively, the depth sensing device 200 may comprise a stereo camera system. The stereo camera may use two offset lenses to capture two slightly different views of the same scene. By comparing the differences between the two images, the system can extract depth information, similar to how human binocular vision works.

In some implementations, the depth sensing device 200 may utilize laser distance and ranging (LIDAR) technology. LIDAR systems may emit laser pulses and measure the reflected pulses with a sensor, allowing precise distance measurements to multiple points in the environment.

In some implementations, the depth sensing device 200 may utilize ultrasonic ranging technology in conjunction with the other sensors to provide coverage in various directions.

The depth sensing device 200 may be configured to capture depth data at regular intervals, effectively providing continuous real-time information about the distances to all surfaces within its operational range limits. The field of view of the depth sensing device 200 may be designed to cover an area in front of and around the user that is relevant for navigation and obstacle avoidance.

In some embodiments, the depth sensing device 200 may be integrated into the electronics enclosure 201, as shown in FIG. 2. However, other configurations are possible. For example, the depth sensing device 200 may be a separate module connected to the main electronics enclosure 201 via a wired or wireless link. This may allow for more flexible positioning of the depth sensor.

In some implementations, the depth sensing device 200 may be complemented by additional sensors to enhance its capabilities. For example, a standard RGB camera may be included alongside the depth sensor to capture color image data. This image data may be used in conjunction with the depth data to improve object recognition and classification.

The depth sensing device 200 may be designed to operate in various lighting conditions, including low light environments. This may be achieved through the use of active infrared illumination in time-of-flight or structured light implementations. For LIDAR-based systems, the laser-based measurements may allow for operation in a wide range of lighting conditions.

The resolution and range of the depth sensing device 200 may be selected based on the specific requirements of the navigation assistance application. Higher resolution may allow for more detailed obstacle detection, while longer range may provide earlier warning of distant obstacles.

Consistent with the embodiments disclosed herein, the wearable pad 210 may include a multiplicity of haptic actuators 211. The actuators 211 may be embodied, at least in part, as any actuator that can produce a discernable sensation on the user's skin to include but not be limited to: eccentric rotating mass (ERM) motor, linear resonant actuator (LRA), piezoelectric haptic actuator (PHA), microfluidic pads, electro-tactile stimulation, capacitive coupled modulated alternating current simulation or any similar device or combination thereof. It is understood that haptic actuator 211 can be any form of haptic stimulation device known to those skilled in the art.

The wearable pad 210 may be configured to be worn on various parts of the user's body, such as the hands, arms, legs, torso, and/or head. In some embodiments, the wearable pad 210 may be integrated into gloves, armbands, or other wearable accessories. The pad 210 may be made of a flexible, breathable material that conforms to the contours of the user's body while allowing for comfortable long-term (e.g., all-day) wear.

The wearable pad 210 may incorporate an array of haptic actuators 211 arranged in a specific spatial configuration. This configuration may correspond to regions of the environment as detected by the depth sensing device 200. For example, a 3×3 grid of actuators on the pad may map to a 3×3 grid of regions in the camera's field of view. The number and arrangement of actuators may vary based on the specific application and/or user preferences.

Each haptic actuator 211 may be capable of producing a range of haptic sensations. These sensations may include vibrations of varying intensity, frequency, and/or duration. In some embodiments, the actuators may also be capable of producing other tactile sensations such as pressure, temperature changes, or texture simulations.

The haptic actuators 211 may be individually controlled by the local control enclosure 240 on the wearable pad. This control enclosure 240 may contain a processor 205 and haptic output drivers 206. The processor 205 may receive actuation commands from the main processing unit 202 (e.g., via the wireless communication link 213). The processor 205 may interpret these commands and use the haptic output drivers 206 to activate the appropriate actuators with the specified patterns and/or intensities.

The binding system 212 of the wearable pad may be designed to securely hold the pad in place during use while allowing for easy removal. This may include adjustable straps, elastic bands, or hook-and-loop fasteners. The binding system 212 may be customizable to accommodate different body sizes and wearing preferences.

In some embodiments, multiple wearable pads may be used simultaneously. For example, a user might wear pads on both hands to receive spatial information about different areas of their environment. The system may be configured to coordinate the haptic feedback across multiple pads to provide a cohesive representation of the surrounding space.

The haptic actuators 211 may be activated in various patterns to convey different types of information. As one non-limiting example, a sequential activation pattern moving from one side of the pad to the other may indicate the direction of an obstacle. As another non-limiting example, the intensity of the vibration may correspond to the proximity of the obstacle, with stronger vibrations indicating closer objects.

The wearable pad 210 may also incorporate a battery 207 to power the local control enclosure 240 and the haptic actuators 211. This battery may be rechargeable and/or easily replaceable. In some embodiments, the pad 210 may include a power-saving mode to extend battery life during periods of inactivity.

The materials used in the construction of the wearable pad 210 and the haptic actuators 211 may be selected for durability and comfort. The pad may be designed to be water-resistant or waterproof to withstand various environmental conditions. The actuators 211 may be sealed to protect against moisture and dust.

In some implementations, the wearable pad 210 may include additional sensors to enhance its functionality. For example, accelerometers or gyroscopes may be incorporated to detect the orientation and movement of the pad. This information could be used to adjust the haptic feedback based on the user's body position or gestures. In some embodiments, the additional sensors may include optional proximity sensors. The optional proximity sensors may be configured to detect the presence of walls or other vertical surfaces at the sides of the user. These sensors may be positioned near the user's elbows or other suitable locations on the user's body, such as on a wearable device or clothing. The proximity sensors may utilize various sensing technologies, including but not limited to ultrasonic sensors, infrared sensors, or capacitive sensors, to effectively determine the proximity of the user to nearby walls or obstacles.

The proximity sensors may be linked to the system's processing unit, which may analyze the data received from the sensors to determine the user's relative position to walls or obstacles. This information may be crucial in environments where pathway boundaries are defined by walls, such as in hallways or narrow passages. The processing unit may use the data from the proximity sensors to enhance the spatial data obtained from the primary depth sensing device, providing a more comprehensive spatial awareness to the user.

The system may generate haptic feedback signals based on the data from the proximity sensors. These signals may inform the user of the proximity to walls or obstacles on their sides, allowing for safer and more confident navigation. The haptic feedback may be delivered through the wearable haptic array, with specific actuators activated to indicate the direction and proximity of the detected surfaces.

Furthermore, the proximity sensors may operate continuously or at predetermined intervals, providing real-time or near-real-time updates to the user. This feature may be particularly useful in dynamic environments where the user's path may be frequently obstructed by moving obstacles or changes in the layout of the surroundings.

In addition to the primary navigation aids provided by the depth sensing device and haptic feedback system, the optional proximity sensors serve as an auxiliary system that enhances the user's ability to maintain a safe distance from walls and navigate effectively through confined or crowded spaces. The integration of these sensors into the system represents a modular approach to designing assistive technologies, where additional components may be added to address specific navigational challenges encountered by visually impaired users.

The system may further comprise optional sensors configured to detect specific types of obstacles such as street signs, including but not limited to stop signs, yield signs, and other signage with relatively small profiles near the ground. These optional sensors may be integrated into the depth sensing device or may operate as standalone units that communicate with the processing unit. The optional sensors may utilize technologies such as optical character recognition (OCR), infrared sensing, or specialized image processing algorithms designed to recognize the shapes and/or symbols typical of street signs.

The optional sensors may enhance the system's ability to provide comprehensive spatial awareness by identifying obstacles that are not easily detectable by standard depth sensing technologies alone. For instance, a stop sign located at the side of a pathway may not present a significant depth variation to be detected by a depth sensor but can be effectively identified by an optical sensor. Once detected, the location and type of the street sign may be processed and included in the environmental data analyzed by the processing unit.

The processing unit may classify the detected street sign as a specific type of static obstacle and assign a corresponding haptic actuation pattern. This pattern may differ from those assigned to other types of obstacles to allow the user to distinguish between general obstacles and important street signs that require particular attention or action, as they indication variations in traffic flow.

Furthermore, the system may adjust the haptic feedback intensity or pattern based on the user's proximity to the detected street sign. As the user approaches closer to the sign, the system may increase the intensity or change the frequency of the haptic feedback to alert the user more strongly, thereby enhancing safety and navigational accuracy.

By integrating these optional sensors and their associated detection and classification capabilities, the system may provide a more detailed and useful representation of the environment, particularly in urban settings where street signs are common and critical for safe navigation. This integration not only aids in obstacle avoidance but also enriches the spatial information provided to the user, facilitating a more informed and confident navigation experience.

The haptic actuators 211 may be calibrated to account for variations in skin sensitivity across different users and/or body locations. The system may include a calibration mode where users can adjust the intensity and/or frequency of the haptic sensations to align with their personal comfort and/or perception levels.

In some embodiments, the wearable pad 210 may incorporate tactile displays capable of creating more complex spatial representations. These may include microfluidic systems that can create dynamic tactile patterns or shape-memory alloys that can produce physical deformations in the pad surface.

While not shown in FIG. 2, it should be appreciated by anyone skilled in the art that various embodiments of the system may comprise more than one depth camera and more than one wearable pad. Also, the location and arrangement of the electronic components and cables are for illustration purposes only and not intended to exclude alternate functionally equivalent variations in arrangement, packaging, cabling, or wireless connection.

While not shown in FIG. 2, it should be appreciated by anyone skilled in the art that one more or computing means may operate in conjunction with the depth sensing device. The computing means may be distributed throughout a system comprised of, for example, the device, the wearable, and, for example, a user's portable computing device (e.g., a smartphone, tablet computer, etc.). In turn, the system can communicate with a remote processing unit (e.g., s remote server) to assist in the processing. In this way, the computing system can benefit from, for example, a neural network of similar devices in order to improve, for example, the recognition aspects of the image processing aspects of the present disclosure.

The computing device 900 may comprise various components configured to process data from the depth sensing device and control the haptic actuators. As shown in FIG. 2, the computing device 900 may include a processing unit 202, an optional graphical processing unit 203, and memory 204.

The processing unit 202 may be configured to execute software algorithms to process the depth data received from the depth sensing device 200. These algorithms may segment the depth data into regions corresponding to different areas of the environment within the field of view of the depth sensing device 200. The processing unit 202 may further classify objects detected within each region based on the depth data.

In some embodiments, the processing unit 202 may comprise a central processing unit (CPU) configured to perform general-purpose computing tasks. The CPU may be a multi-core processor capable of executing multiple threads simultaneously. This may allow for parallel processing of depth data from multiple regions of the environment.

The optional graphical processing unit (GPU) 203 may be included to accelerate certain computationally intensive tasks related to image and depth data processing. For example, the GPU 203 may be utilized for rapid segmentation of the depth data into regions or for running neural network models used in object classification. The inclusion of a GPU may enable more sophisticated real-time processing of the sensor data.

Memory 204 may be provided to store software instructions executed by the processing unit 202, as well as to temporarily store depth data, segmentation results, object classifications, and haptic actuation patterns. The memory 204 may comprise both volatile memory, such as RAM, for rapid access during processing, and non-volatile memory, such as flash storage, for long-term storage of software and configuration data.

The computing device 900 may include a wireless communication module 213 to enable data exchange with the wearable haptic arrays 250. This wireless link may allow the computing device 900 to transmit haptic actuation commands to the local control units on the wearable pads.

A power management system may be included to regulate power consumption of the various components. This may include voltage regulators and power distribution circuitry to supply appropriate power to the processing unit 202, GPU 203, memory 204, and other components. The power management system may interface with an external battery pack 220 to draw power for the computing device 900.

The computing device 900 may be housed within an electronics enclosure 201. This enclosure may be designed to protect the internal components from environmental factors such as moisture and dust. The enclosure 201 may include appropriate thermal management features, such as heat sinks or small fans, to dissipate heat generated by the processing components.

In some embodiments, the computing device 900 may include additional sensors to augment the depth data. For example, an inertial measurement unit (IMU) comprising accelerometers and gyroscopes may be included to track the orientation and movement of the device. This data may be used to adjust the processing of depth information based on the user's motion.

The computing device 900 may also include sufficient input/output interfaces to connect with external devices for configuration, debugging, or data logging purposes. These interfaces may include USB ports, HDMI outputs, or other standard connection types.

Software executing on the computing device 900 may implement various algorithms for processing the depth data. These may include segmentation algorithms to divide the depth data into discrete regions, classification algorithms to identify object types within each region, and pattern generation algorithms to determine appropriate haptic actuation sequences based on the processed environmental data.

The computing device 900 may be configured to operate in real-time or substantially real-time, continuously processing incoming depth data and generating updated haptic actuation commands multiple times per second. This ensures that the feedback provided to the user remains current as they move through the environment.

In some implementations, the computing device 900 may be capable of storing and recalling multiple configuration profiles. These profiles may adjust various processing parameters or haptic feedback patterns to suit different users or environmental conditions.

In some embodiments, the computing device 900 may perform the processing locally. Additionally or alternatively, the computing device 900 may be configured to communicate with remote servers or cloud services. This could enable offloading of computationally intensive tasks or access to larger databases for improved object recognition capabilities.

While not shown in FIG. 2, it should be appreciated by anyone skilled in the art that the wearable pad or pads may be placed anywhere on the body that has a suitable expanse of skin, including but not limited to fingers, hands, arms, legs, head, neck or torso.

FIG. 3 illustrates one possible embodiment of this device as it may be worn by the user 100. In this example, a single electronics enclosure 201 with integrated depth camera is worn on the belt. The battery 220 may be hung from the belt or placed in a pocket, handbag, or fanny pack. One or more wearable haptic arrays 250 are attached at a suitable locations. In the example shown in FIG. 3, two wearable haptic arrays are worn on the top surface of the hands. In some implementations the user is not required to carry the system components other than the wearable haptic array. By way of non-limiting examples, the other (non-remote) system components may be carried by a cart, service animal, wheelchair, or walker.

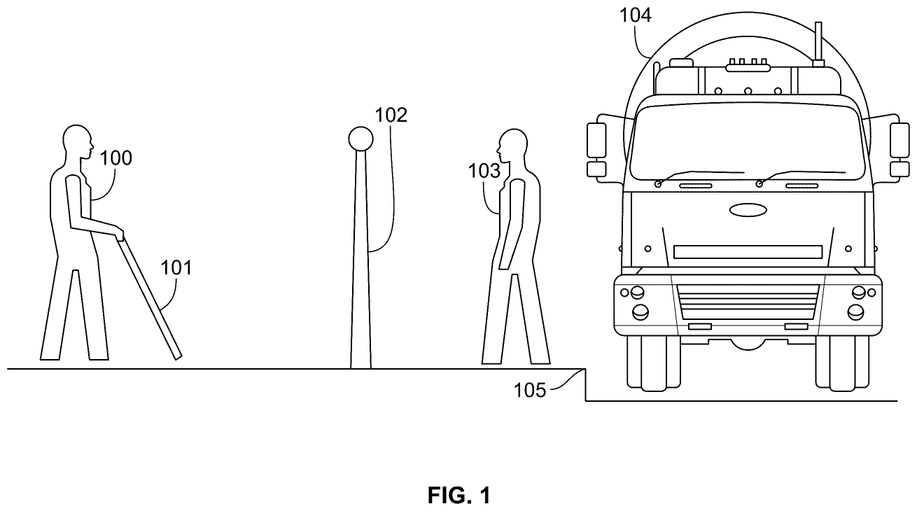

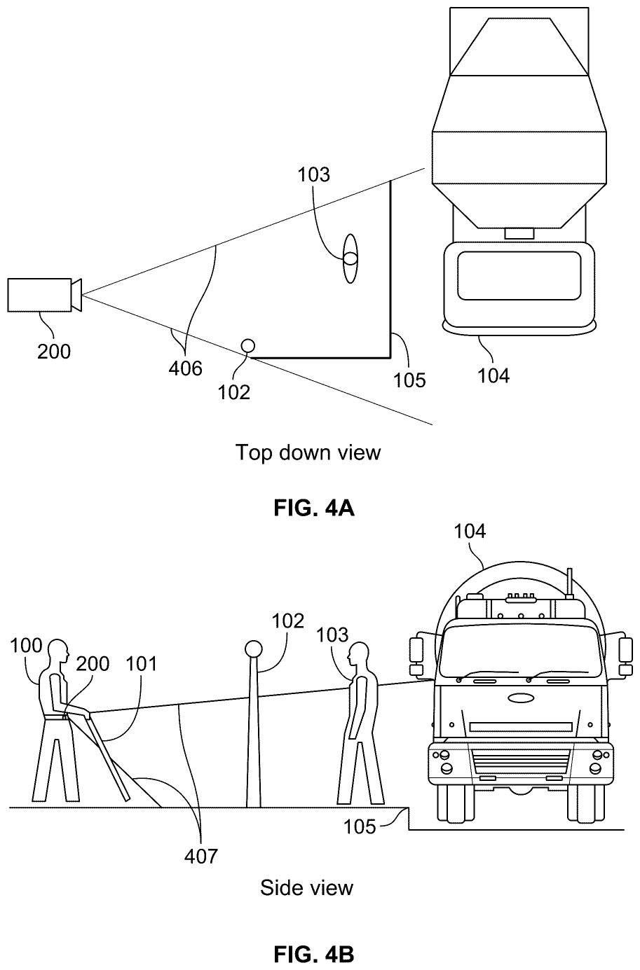

FIGS. 4A and 4B show top down and side views (respectively) of user 100 traversing the example environment presented in FIG. 1. The belt mounted depth camera 200 may be configured to capture the environment, and the corresponding computing elements may be configured to compute the distances to all sample points within the captured field of view boundaries 407 vertically and 406 horizontally (azimuth). Within this sampling boundary, depth camera 200 measures distances to all sample points in the field of view line of sight which, in this example scene, reveals the presence of four obstacles: 1) light post 102, 2) person 103, 3) curb 105, and 4) large truck 104. For each obstacle, the system may determine a distance, a width, and an azimuthal position (e.g., left or right of centerline of view).

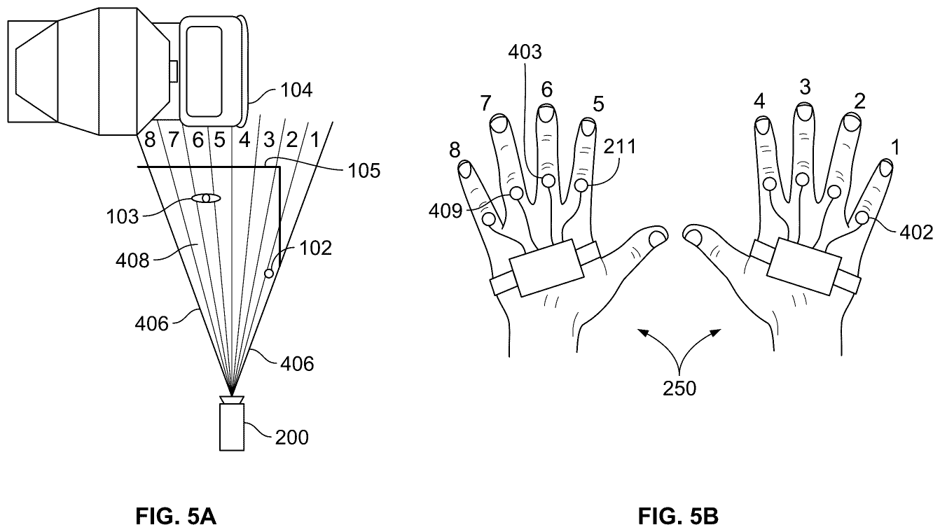

FIG. 5A shows the same top-down view shown in FIG. 4A, with the scene rotated 90 degrees such the user would be positioned at the bottom with depth camera 200. For illustration purposes, shown FIG. 5B is a representation of the user's wearable haptic arrays 250. As shown in FIG. 5B, the haptic arrays 250 include individual haptic elements 211 disposed on the user's fingers. In this representation the wearable haptic arrays 250 are shown such that the row of haptic actuators is positioned with one haptic actuator 211 on each finger creating an array of four actuators on each hand. It should be understood that the orientation and alignment of haptic actuators are illustrated as one possible embodiment. Other arrangements of haptic actuators are contemplated to be within the spirit and scope of the present disclosure.

Referring to the depth camera scene in FIG. 5A, the depth camera 200 field of view (bounded by camera field-of-view 406) creates an area of depth camera coverage having a roughly triangular shape, when viewed from above. In this illustration the camera coverage area is divided into 8 azimuth directional zones 408. The wearable haptic arrays 250 are designed in this example embodiment to have 8 total actuators 211 which yields a one-to-one correspondence between camera azimuthal zones and the haptic actuators. For example, the labelled camera zone 408, which is in the second azimuthal division from the user's left, corresponds to haptic actuator 409 on the ring finger of the user's left hand. Thus, each region 408 in the depth camera's field of view maps to a single haptic actuator at a corresponding relative position on the wearable pads. Accordingly, haptic actuator 402 will correspond to light post 102, haptic actuator 409 will correspond to distant truck obstacle in region 408, haptic actuator 403 will correspond to person 103, and so forth.

Referring again to FIG. 5A, note that several of the regions of in the field of view are occupied by objects of interest to the user. Of greatest importance to the user is knowing which areas are 1) clear of obstacles, 2) have a step or other small vertical offset (e.g., curb), and 3) have an obstacle present and are therefore not passable. In addition to distance, these classifications can be used to assign a characteristic activation signature to a corresponding haptic actuator thereby providing additional information to the user about what is present in the corresponding region. It is understood by anyone skilled in the art that this device may also include the capability to provide classifications for additional categories which are then assigned additional characteristic activation signatures, for example distinguishing between a person and a static obstacle.

### III. Platform Operation

Embodiments of the present disclosure provide a hardware and software platform operative by a set of methods and computer-readable media comprising instructions configured to operate the aforementioned modules and computing elements in accordance with the methods. The following depicts an example of at least one method of a plurality of methods that may be performed by at least one of the aforementioned modules. Various hardware components may be used at the various stages of operations disclosed with reference to each module.

For example, although methods may be described as being performed by a single computing device, it should be understood that, in some embodiments, different operations may be performed by different networked elements in operative communication with the computing device. For example, at least one computing device 900 may be employed in the performance of some or all of the stages disclosed with regard to the methods. Similarly, an apparatus may be employed in the performance of some or all of the stages of the methods. As such, the apparatus may comprise at least those architectural components found in computing device 900.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones described below. For example, stages shown to be sequential may be performed in parallel; moreover, various stages may be added or removed from the without altering or departing from the fundamental scope of the depicted methods and systems disclosed herein.

### A. Method for Conveying Spatial Information to a Visually Impaired User

Consistent with embodiments of the present disclosure, a method may be performed by at least one of the aforementioned modules. The method may be embodied as, for example, but not limited to, computer instructions, which, when executed, perform the method.

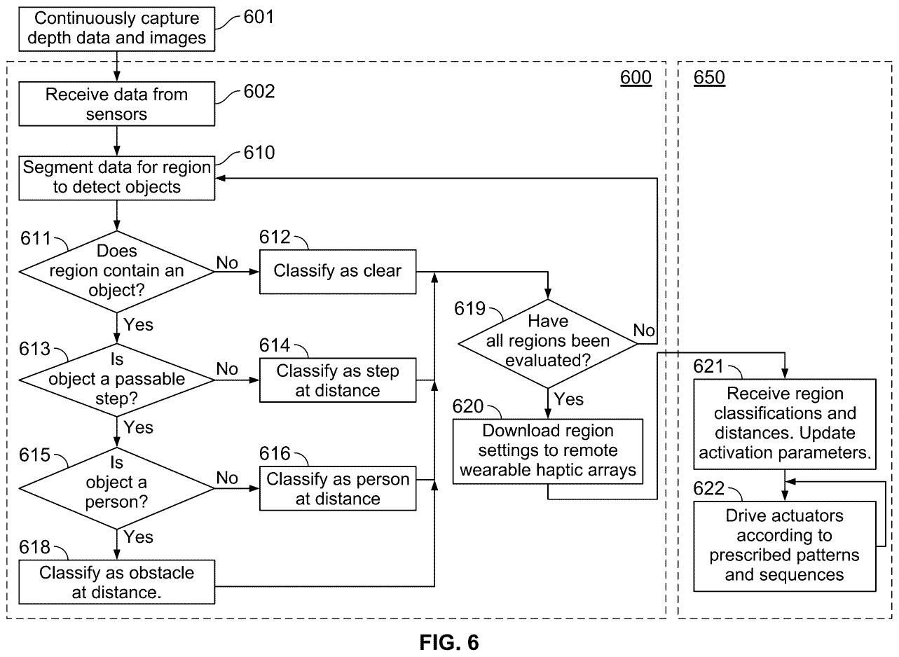

FIG. 6 shows an example data processing flow as a block diagram and flow chart. It will be understood by anyone skilled in the art that, while FIG. 6 shows one specific data flow, there are many variations of the data flow diagram that yield essentially the same functionality.

Depth data (and optionally image data) from sensing camera 200 are captured (e.g., continuously, periodically, intermittently, etc.) at block 601. The captured data is provided as input into the processing electronics 600. The processing electronics 600 may receive and correlate data from all sensors (e.g., the depth sensing camera and any additional optional sensors) at block 602. The correlated data may be segmented into a set of regions at block 610. As described above with respect to FIG. 5A, in some embodiments, the plurality of regions may correspond to azimuthally distinct regions within the environment, although other methods of segmentation are contemplated.

Each region in the field of view may be classified in blocks 611 through 618. As shown, in block 611 it is determined if a region contains any obstacles. If not (NO in block 611) the region may be marked as clear in block 612. If the segment does include an obstacle (YES in block 611), it may be determined whether the obstacle is a passable step in block 613. If the object is identified as a passable step (YES in block 613), the object is classified as a step and the distance to the step is included in the classification at block 614. If the object is not a step (NO in block 613) it is determined whether the object is a person in block 615. If the object is determined to be a person (YES in block 615), the object is classified as a person and the distance to the person is included in the classification at block 616. If the object is determined not to be a person (NO in block 615), then the object may be classified as a generic obstacle at block 618, and a distance to the obstacle may be included in the classification.

Software algorithms process the depth data (and image data if available), applying various criteria to establish whether a region in the field of view can be correlated to one of the predefined classifications. For example, if all the measured points in a region lie roughly on a plane at ground level, this falls into the classification of an unobstructed region that is clear for passage. If multiple measured points in a region exist at elevation significantly above the ground plane, this falls into the classification of an obstacle. In addition to depth data, if image data is present the system may use image recognition algorithms, for example the “You Only Look Once” (YOLO algorithm), to provide additional types of classifications. Although many classifications are possible, the intent is to reduce this to a small set that are relevant to the needs of safe navigation for the user. In block 619, it is determined whether all regions of the data have been processed.

Once all regions are evaluated (YES at block 619), the classifications and distances per region are downloaded (e.g., transmitted) to the wearable haptic device 650 in block 620. The processor module 600 may then “loop back” and return to block 602 to wait for the next sensor input update.

In parallel, the processor on the wearable haptic 650 may receive the data, including at least the region classifications and distances, from the processor module 600, in block 621. In block 622, the wearable haptic 650 may actuate the haptic units to alert the user to the obstacles present in the surrounding area. In embodiments, haptic drivers may activate the haptic actuators with prescribed patterns and sequencing. The pattern and sequencing may be designed to convey, to the user, the data obtained about the obstacles that lie ahead.

The obstacle classifications may be reduced to a small set of unique predetermined haptic actuation patterns, with each pattern being mapped to a particular classification. These patterns may then be memorized by the user. In this way the system can convey to the user the classification of what exists in each region ahead. The user can then decide on an appropriate course of action to navigate the area.

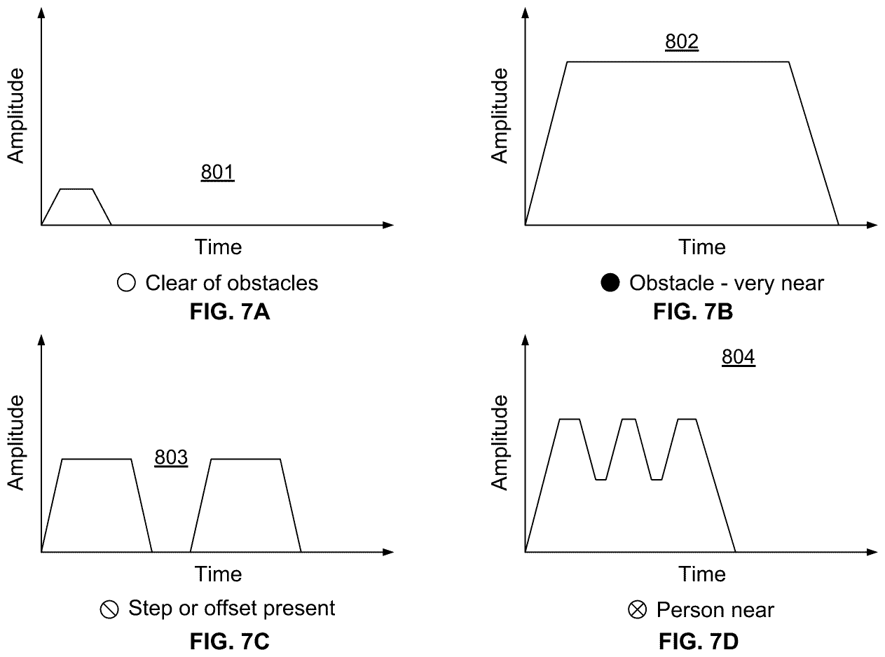

By way of non-limiting example, FIGS. 7A-7D illustrate possible actuation schemes using 4 distinct temporal actuation signatures to represent regions classified as clear, obstacle, step, and person, respectively. As shown in FIG. 7A, the clear signature is a short low-amplitude pulse; FIG. 7B shows that the obstacle signature is a higher amplitude longer pulse, wherein the pulse amplitude and length may be greater the nearer the obstacle is located to the user; FIG. 7C shows that the step signature is similar to an obstacle signature, but includes a single gap in the middle of the pulse; FIG. 7D shows that the person signature is also like an obstacle signature, but includes an amplitude variation (a “wobble”) throughout the pulse duration. With this combination of signatures having variations in temporal shape, magnitude, and duration, it is possible to convey that a particular region is clear or contains an obstacle of a specific type at a distance indicated by the pulse magnitude and/or length. While FIGS. 7A-7D show a particular haptic activation methodology, it should be understood that other actuation patterns, including differing temporal shapes, magnitudes, and/or durations may be used. Any actuation pattern suitable for a user to provide information related to the observed environment is contemplated to be within the spirit and scope of the present disclosure.

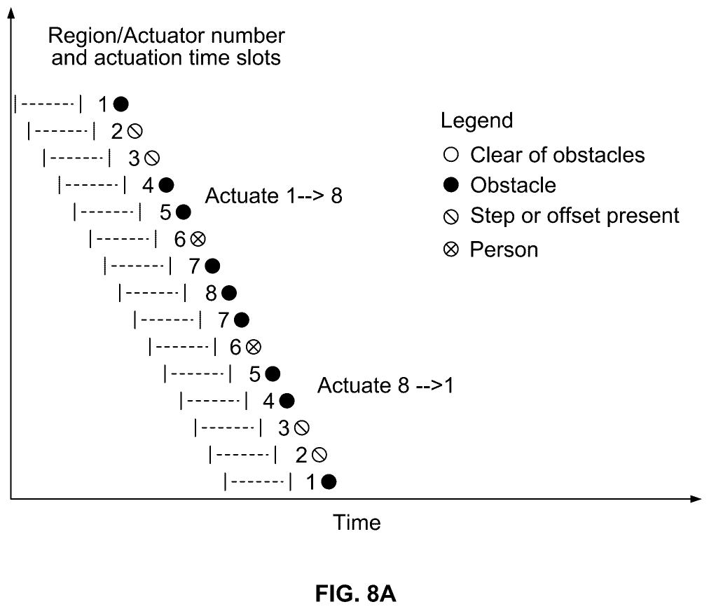

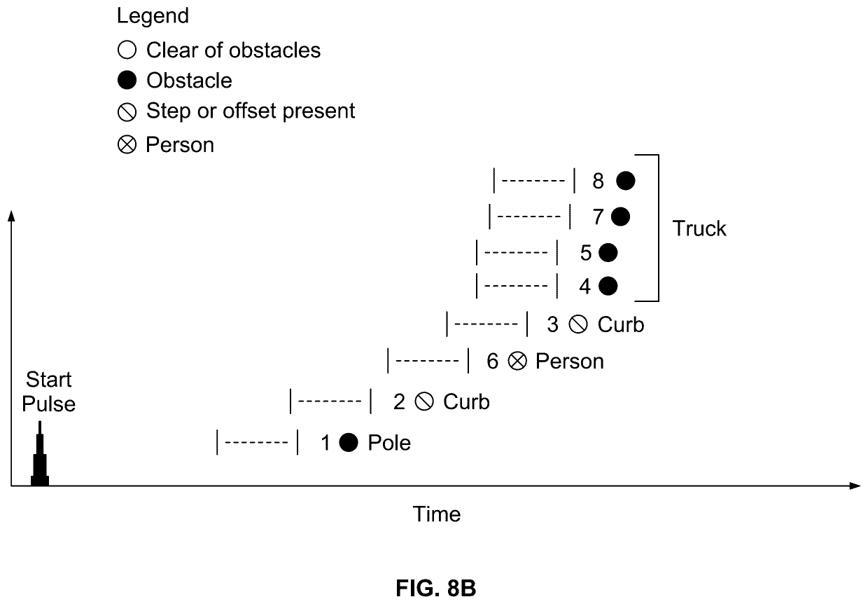

Simultaneous actuation of all haptic actuators concurrently may be difficult for the user to interpret effectively. Accordingly, embodiments of the present disclosure provide for the progressive or sequential activation of the haptic actuators, either singly or small groups. The activation may occur in sequential time slots to maximize perception of the spatial information by the user. By way of non-limiting example, FIG. 8A illustrates one possible timing sequence of haptic actuations. As shown in FIG. 8A, the timing sequence may replicate the sweeping action of a cane probing against the ground. That is the actuators are activated sequentially, from actuator 1 through actuator 8; then in the opposite order, from actuator 8 through actuator 1. The haptic actuators are actuated sequentially with slight delays to give the impression that sensations are occurring in a sweeping motion. While this particular pattern is illustrated and may be familiar to users who are accustomed to walking with a traditional cane, it will be appreciated that other patterns of actuation may be used without departing from the scope of the invention. As an alternate example, FIG. 8B shows another actuation sequencing pattern in which the timing of the haptic actuations may be sequenced according to the distance between the device and the obstacle in each respective region, in a manner that simulates an outward-moving wave (hereafter the “radar” mode). FIG. 8B illustrates the activation of the haptic actuators in the radar mode for the scene depicted in FIG. 5A. An optional initial small “start” pulse signals the start of a particular cycle. Thereafter, activation of each haptic actuator is delayed by a time dependent on a distance from the device to an object of interest in the actuator's respective region. In FIG. 5A, the object nearest the device is pole 102 in region 1, which results in the actuator associated with region 1 being the first to activate. Based on distance, actuators 2, 6, and 3 follow in sequence with their respective patterns. Finally, actuators 4, 5, 7, and 8 actuate almost simultaneously, indicating a broad obstruction at that distance. Note that this final group of actuators is almost entirely on the left hand, providing an intuitive spatial indication that there is a substantial, distant obstruction spanning from center to the left. Once complete, the entire cycle repeats as frequently as the timing permits.

The haptic signature for each actuator may be based on the data obtained from the environment. For example, the indications shown in FIGS. 8A and 8B represent the environment illustrated in FIG. 5A. In these examples, there are 8 haptic actuators arranged in 2 pads of 4 actuators, each with 4 possible actuation signatures as designated by the legend. Note in this example that, although the truck is slightly beyond the curb, the preferred signal is an obstacle since stepping off the curb immediately contacts the truck.

The actuation pattern involves at least two properties: 1) sequencing of actuation of haptic actuators to aid user in perceiving the relative position of the region, and 2) the particular actuation signature to convey type and distance of obstacle detected (if any). The resulting sequential progression aids the user in perceiving the relative positions of the haptic stimuli in a meaningful way.

Again, referring to FIG. 8A, an important feature of the actuation pattern is that every haptic actuator provides at least a small signal to the user, even haptic actuators for locations that are classified as “Clear”. The execution of the haptic actuator signals being sequenced in succession creates a wave-like progression of sensations moving along the user's fingers. This wave-like progression greatly aids the user in discerning the relative positions of haptic signals thereby aiding in the creation of an internal perception of the geometry of the regions being conveyed by the wearable haptic arrays. This technique mitigates sensory overload and the associated loss of coherent perception of the mapping of haptic stimuli to location. Anyone skilled in the art will recognize that the example in sequences in FIGS. 8A and 8B illustrate two of many possible progression possibilities that can be utilized to convey a sensory progression across the skin in a way that is readily interpretable by a user.

In addition to showing the timing of the actuations, FIGS. 8A and 8B also illustrate the second characteristic of the haptic actuation scheme. That is, each haptic actuator utilizes a different actuation signature, wherein the particular signature is a specific combination of temporal amplitude, vibration frequency and total duration to convey what type of obstacle, if any, is present in each region and the relative distance to the obstacle. A user's ability to distinguish these actuation differences is generally very limited, so only a few variations can be successfully discerned. This example is not intended to limit the choices of haptic actuation signatures and those skilled in the art will recognize that there are a nearly infinite variety of choices in haptic actuation signatures and that vibration frequency may also be used to further differentiate the signatures.

The example sequences as described in FIGS. 7, 8A, and 8B utilize all the available haptic actuators in the wearable haptic array; however, it can be recognized by anyone skilled in the art that it may be beneficial in some scenarios for the coverage of the array to be temporarily altered such that some areas (and their corresponding actuators) are unused and unactuated. An example scenario would be one in which there are very near obstacles that must be avoided immediately. In this scenario truncating the sequence to skip the far-away regions enables faster repeat sequences of the nearest regions.

In yet further embodiments (e.g., where a traditional camera is incorporated), the system may be augmented with object recognition software, which can be used to semantically classify objects in images captured by a camera. The object recognition software may execute on the local computation unit, a user's portable device and/or on a remote server. Referring to FIG. 4, semantic classification would identify item 102 as a pole, 103 as a person, and 104 as a vehicle. An internal database could then assign attributes to these items such as “fixed” or “mobile”. Consistent with embodiments of the present disclosure, attributes that are important to the user could be assigned additional haptic signatures to improve the user's perception of the environment. Semantic classification is especially advantageous in correctly identifying hazardous objects such as vehicles moving toward the user. Similarly, knowing that an obstacle is a person and not a pole elicits a different strategy for navigation. In some embodiments a database of known persons may be stored (e.g., locally or remotely), and when a person is identified, the features of the person may be compared to those of known persons in the database. The system may be configured to identify the known persons, allowing the user to greet or otherwise interact with the person from a distance.

As another aspect of the disclosed concepts, additional means of notification may be employed to alert the user to situations of high importance. In particular, items that represent hazards that require immediate attention may elicit a larger response from the system when detected. As an example, if the system identifies a vehicle and determines that it is moving toward the user, the system may alert the user via an alarm. Examples of such notifications would include but not be limited to audio alarms or audio verbal messages such as “vehicle right” and/or specially designated haptic actuators that do not participate in the normal functioning of the wearable haptic array.

### IV. Hardware Architecture

Embodiments of the present disclosure provide a hardware and software platform operative as a distributed system of modules and computing elements.

The system may be embodied as, for example, but not be limited to, a website, a web application, a desktop application, a backend application, and a mobile application compatible with a computing device 900. As shown in FIGS. 2 and 9, the computing device 900 may comprise, but not be limited to, the following:
Mobile computing device, such as, but is not limited to, a laptop, a tablet, a smartphone, a drone, a wearable, an embedded device, a handheld device, an Arduino, an industrial device, or a remotely operable recording device;
A supercomputer, an exascale supercomputer, a mainframe, or a quantum computer;
A minicomputer or microcomputer, wherein the minicomputer or microcomputer computing device comprises, but is not limited to, a microcontroller, a workstation, or a mini-PC (e.g., a Mac mini or Intel NUC), a server, wherein a server may be rack-mounted an industrial device, a raspberry pi, a desktop, or an embedded device

Portions of the system may be hosted on a centralized server or a cloud computing service. Although the method of operation of the system has been described to be performed by a computing device 900, it should be understood that, in some embodiments, different operations may be performed by a plurality of the computing devices 900 in operative communication on at least one network.

Embodiments of the present disclosure may comprise a system having a central processing unit (CPU) 920, a bus 930, a memory unit 940, a power supply unit (PSU) 950, and one or more Input/Output (I/O) units. The CPU 920 coupled to the memory unit 940 and the plurality of I/O units 960 via the bus 930, all of which are powered by the PSU 950. It should be understood that, in some embodiments, each disclosed unit may actually be a plurality of such units for redundancy, high availability, and/or performance purposes. The combination of the presently disclosed units is configured to perform the stages of any method disclosed herein.

FIG. 9 is a block diagram of a system including computing device 900. Consistent with an embodiment of the disclosure, the aforementioned CPU 920, the bus 930, the memory unit 940, a PSU 950, and the plurality of I/O units 960 may be implemented in a computing device, such as computing device 900 of FIG. 9. Any suitable combination of hardware, software, or firmware may be used to implement the aforementioned units. For example, the CPU 920, the bus 930, and the memory unit 940 may be implemented with computing device 900 or any of other computing devices 900, in combination with computing device 900. The aforementioned system, device, and components are examples and other systems, devices, and components may comprise the aforementioned CPU 920, the bus 930, and the memory unit 940, consistent with embodiments of the disclosure.

At least one computing device 900 may be embodied as any of the computing elements illustrated in all of the attached figures. A computing device 900 does not need to be electronic, nor even have a CPU 920, nor bus 930, nor memory unit 940. The definition of the computing device 900 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 900, especially if the processing is purposeful.

With reference to FIG. 9, a system consistent with an embodiment of the disclosure may include a computing device, such as computing device 900. In some configurations, the computing device 900 may include at least one clock module 910, at least one CPU 920, at least one bus 930, and at least one memory unit 940, at least one PSU 950, and at least one I/0 960 module, wherein I/O module may be comprised of, but not limited to a non-volatile storage sub-module 961, a communication sub-module 962, a sensors sub-module 963, and a peripherals sub-module 964.

In a system consistent with an embodiment of the disclosure, the computing device 900 may include the clock module 910, known to a person having ordinary skill in the art as a clock generator, which produces clock signals. Clock signals may oscillate between a high state and a low state at a controllable rate, and may be used to synchronize or coordinate actions of digital circuits. Most integrated circuits (ICs) of sufficient complexity use a clock signal in order to synchronize different parts of the circuit, cycling at a rate slower than the worst-case internal propagation delays. One well-known example of the aforementioned integrated circuit is the CPU 920, the central component of modern computers, which relies on a clock signal. The clock 910 can comprise a plurality of embodiments, such as, but not limited to, a single-phase clock which transmits all clock signals on effectively 1 wire, a two-phase clock which distributes clock signals on two wires, each with non-overlapping pulses, and a four-phase clock which distributes clock signals on 4 wires.

Many computing devices 900 may use a “clock multiplier” which multiplies a lower frequency external clock to the appropriate clock rate of the CPU 920. This allows the CPU 920 to operate at a much higher frequency than the rest of the computing device 900, which affords performance gains in situations where the CPU 920 does not need to wait on an external factor (like memory 940 or input/output 960). Some embodiments of the clock 910 may include dynamic frequency change, where, the time between clock edges can vary widely from one edge to the next and back again.

In a system consistent with an embodiment of the disclosure, the computing device 900 may include the CPU 920 comprising at least one CPU Core 921. In other embodiments, the CPU 920 may include a plurality of identical CPU cores 921, such as, but not limited to, homogeneous multi-core systems. It is also possible for the plurality of CPU cores 921 to comprise different CPU cores 921, such as, but not limited to, heterogeneous multi-core systems, big. LITTLE systems and some AMD accelerated processing units (APU). The CPU 920 reads and executes program instructions which may be used across many application domains, for example, but not limited to, general purpose computing, embedded computing, network computing, digital signal processing (DSP), and graphics processing (GPU). The CPU 920 may run multiple instructions on separate CPU cores 921 simultaneously. The CPU 920 may be integrated into at least one of a single integrated circuit die, and multiple dies in a single chip package. The single integrated circuit die and/or the multiple dies in a single chip package may contain a plurality of other elements of the computing device 900, for example, but not limited to, the clock 910, the bus 930, the memory 940, and I/O 960.

The CPU 920 may contain cache 922 such as but not limited to a level 1 cache, a level 2 cache, a level 3 cache, or combinations thereof. The cache 922 may or may not be shared amongst a plurality of CPU cores 921. The cache 922 sharing may comprise at least one of message passing and inter-core communication methods used for the at least one CPU Core 921 to communicate with the cache 922. The inter-core communication methods may comprise, but not be limited to, bus, ring, two-dimensional mesh, and crossbar. The aforementioned CPU 920 may employ symmetric multiprocessing (SMP) design.

The one or more CPU cores 921 may comprise soft microprocessor cores on a single field programmable gate array (FPGA), such as semiconductor intellectual property cores (IP Core). The architectures of the one or more CPU cores 921 may be based on at least one of, but not limited to, Complex Instruction Set Computing (CISC), Zero Instruction Set Computing (ZISC), and Reduced Instruction Set Computing (RISC). At least one performance-enhancing method may be employed by one or more of the CPU cores 921, for example, but not limited to Instruction-level parallelism (ILP) such as, but not limited to, superscalar pipelining, and Thread-level parallelism (TLP).

Consistent with the embodiments of the present disclosure, the aforementioned computing device 900 may employ a communication system that transfers data between components inside the computing device 900, and/or the plurality of computing devices 900. The aforementioned communication system will be known to a person having ordinary skill in the art as a bus 930. The bus 930 may embody internal and/or external hardware and software components, for example, but not limited to a wire, an optical fiber, various communication protocols, and/or any physical arrangement that provides the same logical function as a parallel electrical bus. The bus 930 may comprise at least one of a parallel bus, wherein the parallel bus carries data words in parallel on multiple wires; and a serial bus, wherein the serial bus carries data in bit-wise serial form. The bus 930 may embody a plurality of topologies, for example, but not limited to, a multidrop/electrical parallel topology, a daisy chain topology, and connected by switched hubs, such as a USB bus. The bus 930 may comprise a plurality of embodiments, for example, but not limited to:
Internal data bus (data bus) 931/Memory bus
Control bus 932
Address bus 933
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
Inter-Integrated Circuit (a.k.a. I2C, I2C, IIC) bus
Serial Peripheral Interface (SPI)
1-Wire
Peripheral Component Interconnect (PCI), including embodiments such as but not limited to, Accelerated Graphics Port (AGP), Peripheral Component Interconnect extended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal IO, Thunderbolt/Mini DisplayPort, Mobile PCle (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and extensible Host Controller Interface (xHCI).

Consistent with the embodiments of the present disclosure, the aforementioned computing device 900 may employ hardware integrated circuits that store information for immediate use in the computing device 900, known to persons having ordinary skill in the art as primary storage or memory 940. The memory 940 operates at high speed, distinguishing it from the non-volatile storage sub-module 961, which may be referred to as secondary or tertiary storage, which provides relatively slower-access to information but offers higher storage capacity. The data contained in memory 940, may be transferred to secondary storage via techniques such as, but not limited to, virtual memory and swap. The memory 940 may be associated with addressable semiconductor memory, such as integrated circuits consisting of silicon-based transistors, that may be used as primary storage or for other purposes in the computing device 900. The memory 940 may comprise a plurality of embodiments, such as, but not limited to volatile memory, non-volatile memory, and semi-volatile memory. It should be understood by a person having ordinary skill in the art that the following are non-limiting examples of the aforementioned memory:
Volatile memory, which requires power to maintain stored information, for example, but not limited to, Dynamic Random-Access Memory (DRAM) 941, Static Random-Access Memory (SRAM) 942, CPU Cache memory 925, Advanced Random-Access Memory (A-RAM), and other types of primary storage such as Random-Access Memory (RAM).
Non-volatile memory, which can retain stored information even after power is removed, for example, but not limited to, Read-Only Memory (ROM) 943, Programmable ROM (PROM) 944, Erasable PROM (EPROM) 945, Electrically Erasable PROM (EEPROM) 946 (e.g., flash memory and Electrically Alterable PROM [EAPROM]), Mask ROM (MROM), One Time Programmable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory may have limited non-volatile duration after power is removed but may lose data after said duration has passed. Semi-volatile memory provides high performance, durability, and other valuable characteristics typically associated with volatile memory, while providing some benefits of true non-volatile memory. The semi-volatile memory may comprise volatile and non-volatile memory, and/or volatile memory with a battery to provide power after power is removed. The semi-volatile memory may comprise, but is not limited to, spin-transfer torque RAM (STT-RAM).

Consistent with the embodiments of the present disclosure, the aforementioned computing device 900 may employ a communication system between an information processing system, such as the computing device 900, and the outside world, for example, but not limited to, human, environment, and another computing device 900. The aforementioned communication system may be known to a person having ordinary skill in the art as an Input/Output (I/O) module 960. The I/O module 960 regulates a plurality of inputs and outputs with regard to the computing device 900, wherein the inputs are a plurality of signals and data received by the computing device 900, and the outputs are the plurality of signals and data sent from the computing device 900. The I/O module 960 interfaces with a plurality of hardware, such as, but not limited to, non-volatile storage 961, communication devices 962, sensors 963, and peripherals 964. The plurality of hardware is used by at least one of, but not limited to, humans, the environment, and another computing device 900 to communicate with the present computing device 900. The I/O module 960 may comprise a plurality of forms, for example, but not limited to channel I/O, port mapped I/O, asynchronous I/O, and Direct Memory Access (DMA).

Consistent with the embodiments of the present disclosure, the aforementioned computing device 900 may employ a non-volatile storage sub-module 961, which may be referred to by a person having ordinary skill in the art as one of secondary storage, external memory, tertiary storage, off-line storage, and auxiliary storage. The non-volatile storage sub-module 961 may not be accessed directly by the CPU 920 without using an intermediate area in the memory 940. The non-volatile storage sub-module 961 may not lose data when power is removed and may be orders of magnitude less costly than storage used in memory 940. Further, the non-volatile storage sub-module 961 may have a slower speed and higher latency than in other areas of the computing device 900. The non-volatile storage sub-module 961 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (961) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD+RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).

Consistent with the embodiments of the present disclosure, the computing device 900 may employ a communication sub-module 962 as a subset of the I/O module 960, which may be referred to by a person having ordinary skill in the art as at least one of, but not limited to, a computer network, a data network, and a network. The network may allow computing devices 900 to exchange data using connections, which may also be known to a person having ordinary skill in the art as data links, which may include data links between network nodes. The nodes may comprise networked computer devices 900 that may be configured to originate, route, and/or terminate data. The nodes may be identified by network addresses and may include a plurality of hosts consistent with the embodiments of a computing device 900. Examples of computing devices that may include a communication sub-module 962 include, but are not limited to, personal computers, phones, servers, drones, and networking devices such as, but not limited to, hubs, switches, routers, modems, and firewalls.

Two nodes can be considered networked together when one computing device 900 can exchange information with the other computing device 900, regardless of any direct connection between the two computing devices 900. The communication sub-module 962 supports a plurality of applications and services, such as, but not limited to World Wide Web (WWW), digital video and audio, shared use of application and storage computing devices 900, printers/scanners/fax machines, email/online chat/instant messaging, remote control, distributed computing, etc. The network may comprise one or more transmission mediums, such as, but not limited to conductive wire, fiber optics, and wireless signals. The network may comprise one or more communications protocols to organize network traffic, wherein application-specific communications protocols may be layered, and may be known to a person having ordinary skill in the art as being improved for carrying a specific type of payload, when compared with other more general communications protocols. The plurality of communications protocols may comprise, but are not limited to, IEEE 802, ethernet, Wireless LAN (WLAN/Wi-Fi), Internet Protocol (IP) suite (e.g., TCP/IP, UDP, Internet Protocol version 4 [IPv4], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], Integrated Digital Enhanced Network [IDEN], Long Term Evolution [LTE], LTE-Advanced [LTE-A], and fifth generation [5G] communication protocols).

The communication sub-module 962 may comprise a plurality of size, topology, traffic control mechanisms and organizational intent policies. The communication sub-module 962 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G, 4G (such as WiMAX and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line communications

The aforementioned network may comprise a plurality of layouts, such as, but not limited to, bus networks such as Ethernet, star networks such as Wi-Fi, ring networks, mesh networks, fully connected networks, and tree networks. The network can be characterized by its physical capacity or its organizational purpose. Use of the network, including user authorization and access rights, may differ according to the layout of the network. The characterization may include, but is not limited to a nanoscale network, a Personal Area Network (PAN), a Local Area Network (LAN), a Home Area Network (HAN), a Storage Area Network (SAN), a Campus Area Network (CAN), a backbone network, a Metropolitan Area Network (MAN), a Wide Area Network (WAN), an enterprise private network, a Virtual Private Network (VPN), and a Global Area Network (GAN).

Consistent with the embodiments of the present disclosure, the aforementioned computing device 900 may employ a sensors sub-module 963 as a subset of the I/O 960. The sensors sub-module 963 comprises at least one of the device, module, or subsystem whose purpose is to detect events or changes in its environment and send the information to the computing device 900. Sensors may be sensitive to the property they are configured to measure, may not be sensitive to any property not measured but be encountered in its application, and may not significantly influence the measured property. The sensors sub-module 963 may comprise a plurality of digital devices and analog devices, wherein if an analog device is used, an Analog to Digital (A-to-D) converter must be employed to interface the said device with the computing device 900. The sensors may be subject to a plurality of deviations that limit sensor accuracy. The sensors sub-module 963 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Acoustic, sound and vibration sensors, such as, but not limited to, microphone, lace sensors such as a guitar pickup, seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, moisture alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Navigation sensors, such as, but not limited to, airspeed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as but not limited to, accelerometer, displacement sensor, flex sensor, free-fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, colorimeter, contact image sensor, electro-optical sensor, infra-red sensor, kinetic inductance detector, LED configured as a light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch,, triangulation sensor, touch switch, and wired glove.

Consistent with the embodiments of the present disclosure, the aforementioned computing device 900 may employ a peripherals sub-module 964 as a subset of the I/O 960. The peripheral sub-module 964 comprises ancillary devices used to put information into and get information out of the computing device 900. There are 3 categories of devices comprising the peripheral sub-module 964, which exist based on their relationship with the computing device 900, input devices, output devices, and input/output devices. Input devices send at least one of data and instructions to the computing device 900. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to the position of a mouse.
The number of degrees of freedom involved, such as, but not limited to, two-dimensional mice and three-dimensional mice used for Computer-Aided Design (CAD) applications.

Output devices provide output from the computing device 900. Output devices convert electronically generated information into a form that can be presented to humans. Input /utput devices perform that perform both input and output functions. It should be understood by a person having ordinary skill in the art that the ensuing are non-limiting embodiments of the aforementioned peripheral sub-module 964:
Input Devices
   Human Interface Devices (HID), such as, but not limited to, pointing device (e.g., mouse, touchpad, joystick, touchscreen, game controller/gamepad, remote, light pen, light gun, infrared remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, that require up to six degrees of freedom such as, but not limited to, camera gimbals, Cave Automatic Virtual Environment (CAVE), and virtual reality systems.
   Video Input devices are used to digitize images or video from the outside world into the computing device 900. The information can be stored in a multitude of formats depending on the user's requirement. Examples of types of video input devices include, but are not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device to capture produced sound. Audio input devices allow a user to send audio signals to the computing device 900 for at least one of processing, recording, and carrying out commands. Devices such as microphones allow users to speak to the computer to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
   Data AcQuisition (DAQ) devices convert at least one of analog signals and physical parameters to digital values for processing by the computing device 900. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Haptic devices may convert electrical information to haptic feedback, creating an experience of touch by applying forces, vibrations, or motions to the user. Haptic feedback may include controlled vibrations at set frequencies and intervals to provide a particular sensation, including ‘bumps’, ‘knocks’, and ‘taps’. Electronics offering haptic feedback may an eccentric rotating mass (ERM) actuator and/or a piezoelectric actuator to produce vibrations. Additionally or alternatively, ultrasonic technologies and/or electrical stimulation can be used to create haptic sensations in the skin or muscles of the user.
   Display devices may convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).
   Audio and Video (AV) devices, such as, but not limited to, speakers, headphones, amplifiers, and lights, and lasers.
   Other devices such as Digital to Analog Converter (DAC)
Input/Output Devices may further comprise, but not be limited to, touchscreens, networking devices (e.g., devices disclosed in network sub-module 962), data storage devices (non-volatile storage 961), facsimile (FAX), and graphics/sound cards.

All rights, including copyrights in the code included herein, are vested in and the property of the Applicant. The Applicant retains and reserves all rights in the code included herein, and grants permission to reproduce the material only in connection with the reproduction of the granted patent and for no other purpose.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A system for conveying spatial information to a visually impaired user, the system comprising:
a depth sensing device configured to capture depth data of an environment;
a processing unit configured to:
receive the depth data from the depth sensing device,
segment the depth data into a plurality of regions,
classify objects within each of the plurality of regions, and
generate haptic actuation patterns based on the classified objects; and
a wearable haptic array comprising a plurality of haptic actuators, wherein each haptic actuator corresponds to one of the plurality of regions,
wherein the processing unit is further configured to activate the plurality of haptic actuators according to the generated haptic actuation patterns to convey spatial information about the environment to the user.

2. The system of claim 1, wherein the activation of the plurality of haptic actuators is a sequential activation that creates a wave-like progression of haptic sensations.

3. The system of claim 2, wherein the wave-like progression simulates movement of a virtual probing cane.

4. The system of claim 1, wherein the activation of the plurality of haptic actuators simulates progression of a virtual outward-moving wave or radar system.

5. The system of claim 1, wherein the haptic actuation patterns comprise different actuation signatures for different object classifications.

6. The system of claim 5, wherein the different actuation signatures vary in at least one of temporal amplitude, vibration frequency, or total duration.

7. The system of claim 1, wherein the processing unit is further configured to generate a perceptible null signal for regions classified as clear of obstacles.

8. The system of claim 1, further comprising an image capture device, wherein the processing unit is further configured to:
receive image data from the image capture device,
perform semantic classification of objects in the image data, and
modify the haptic actuation patterns based on the semantic classification.

9. The system of claim 1, wherein the wearable haptic array comprises at least two pads, each pad comprising a subset of the plurality of haptic actuators.

10. The system of claim 9, wherein the at least two pads are configured to be worn on the user's hands.

11. A method for conveying spatial information to a visually impaired user, the method comprising:
capturing depth data of an environment using a depth sensing device;
segmenting the depth data into a plurality of regions;
classifying objects within each of the plurality of regions;
generating haptic actuation patterns based on the classified objects; and
activating a plurality of haptic actuators on a wearable haptic array according to the generated haptic actuation patterns, wherein each haptic actuator corresponds to one of the plurality of regions,
wherein the sequential activation conveys spatial information about the environment to the user.

12. The method of claim 11, wherein activating the plurality of haptic actuators creates a wave-like progression of haptic sensations.

13. The method of claim 12, wherein the wave-like progression simulates movement of a virtual probing cane.

14. The method of claim 12, wherein the wave-like progression simulates progression of a virtual outward-moving wave or radar system.

15. The method of claim 11, wherein the haptic actuation patterns comprise different actuation signatures for different object classifications.

16. The method of claim 15, wherein the different actuation signatures vary in at least one of temporal amplitude, vibration frequency, or total duration.

17. The method of claim 11, further comprising generating a perceptible null signal for regions classified as clear of obstacles.

18. The method of claim 11, further comprising:
capturing image data of the environment;
performing semantic classification of objects in the image data; and
modifying the haptic actuation patterns based on the semantic classification.

19. An apparatus for conveying spatial information to a visually impaired user, the apparatus comprising:
a wearable haptic array comprising a plurality of haptic actuators; and
a processing unit configured to:
receive depth data of an environment from a depth sensing device,
segment the depth data into a plurality of regions,
classify objects within each of the plurality of regions,
generate haptic actuation patterns based on the classified objects, and
sequentially activate the plurality of haptic actuators according to the generated haptic actuation patterns to convey spatial information about the environment to the user, wherein each haptic actuator corresponds to one of the plurality of regions.

20. The apparatus of claim 19, wherein the sequential activation of the plurality of haptic actuators creates a wave-like progression of haptic sensations.
